(19) United States
(12) Patent Application Publication
(10) Pub. No.: US 2025/0214848 A1
(43) Pub. Date: Jul. 3, 2025

(54) SYNTHESIS OF B-ORIENTED MFI IN THE PRESENCE OF WATER-SOLUBLE OXIDIZED DISULFIDE OIL AND FLUORIDE MINERALIZER

(71) Applicant: SAUDI ARABIAN OIL COMPANY, Dhahran (SA)

(72) Inventors: Robert Peter Hodgkins, Dhahran (SA); Omer Refa Koseoglu, Istanbul (TR)

(73) Assignee: SAUDI ARABIAN OIL COMPANY, Dhahran (SA)

(21) Appl. No.: 18/419,144

(22) Filed: Jan. 22, 2024

Related U.S. Application Data
(60) Provisional application No. 63/615,518, filed on Dec. 28, 2023.

(51) Int. Cl. C01B 37/02

(52) U.S. Cl. CPC C01B 37/02; C01P 2002/72; C01P 2002/77; C01P 2002/86

(57) ABSTRACT

Methods are provided for hydrothermal synthesis of b-oriented MFI zeolite. The method generally comprises forming a solution of precursors and reagents in effective ratios for a b-oriented MFI zeolite including a fluoride-containing mineralizer, and water-soluble oxidized disulfide oil. The solution is hydrothermally treated under effective conditions and for an effective time to synthesize b-oriented MFI zeolite.

### RELATED APPLICATIONS

This application claims priority to U.S. Provisional Patent Application No. 63/615,518 filed Dec. 28, 2023, which is incorporated herein by reference in its entirety.

### FIELD OF THE DISCLOSURE

The present disclosure relates to methods of synthesizing b-oriented MFI zeolites.

### BACKGROUND OF THE DISCLOSURE

Zeolites possess well-defined structures and uniform pore sizes that can be measured in angstroms (Å). For example, zeolites include aluminosilicates or pure silica zeolites, having framework atoms arranged as tetrahedra. Zeolites occur naturally and are synthesized in various forms, and can be made or selected with a controlled porosity and other characteristics. Such materials typically contain cations, water and/or other molecules located in the porous network. Hundreds of natural and synthetic porous crystalline materials with various framework types exist with a wide range of applications. The unique properties of zeolites and the ability to tailor them for specific applications has resulted in their extensive use in industry as catalysts, molecular sieves, adsorbents and ion exchange materials. The pores of zeolites can form active sites for catalytic reactions, and can also form channels that are selective for the passage of certain compounds and/or isomers to the exclusion of others. Zeolites also can be effective as catalytic materials or adsorbents, alone or with the addition of active components. Zeolites are typically synthesized hydrothermally from which crystals precipitate from a gel, using water as a solvent.

Another class of zeolites includes pure silica zeolites (PSZs), which are composed of SiO₄ tetrahedra. There is a rich variety as to how these tetrahedra link together to form the many different possible framework structures. The manner in which connectivity of tetrahedra varies and how this affects the Si—O bonds, Si—O—Si and O—Si—O angles, and their value ranges, are of great interest. PSZs are interesting materials because they are highly thermally stable, structurally diverse, chemically simple (silica polymorphs), and closely related to catalytically-effective materials. Many of these have been well-characterized by single-crystal and powder diffraction techniques. For instance, a detailed list of PSZs is given in the review paper by David S. Wragg, Russell E. Morris, and Allen W. Burton, Pure Silica Zeolite-type Frameworks: A Structural Analysis, Chem. Mater. 2008, 20, 1561-1570; this publication provides information on their currently available structural data, and is incorporated by reference herein in its entirety.

ZSM-5 zeolites possess a MFI framework, an orthorhombic structure and belonging to the pentasil family. ZSM-5 possesses micropore sizes related to the 10-member rings when viewed along the [100] and [010] directions of 5.5×5.1 Å and 5.6×5.3 Å, respectively. The general formula is NaₙAlₙSi₉₆₋ₙO₁₉₂.16H₂O (0<n<27)). ZSM-5 zeolites have pore dimensions that results in the formation of channels of suitable size and shape for selective passage for xylene isomers. For example, in a mixture of p-, o- and m-xylenes, p-xylene readily passes through the channels of ZSM-5 catalysts due to its linear configuration, while diffusion of o-xylene and m-xylene is hindered.

Methods for preparing ZMS-5 are known, typical of zeolite syntheses via hydrothermal means from which crystals precipitate from a gel using water as a solvent. For example. U.S. Pat. No. 3,702,886, the entire contents of which are incorporated herein by reference, discloses a process for preparing ZSM-5 using a mixture of alkali metal cations and tetraalkylammonium cations, such as tetrapropylammonium (TPA) cations as a template or structure directing agent to direct the synthesis of the ZSM-5 structure. Numerous variations of this method are known, and it is appreciated that the physical and catalytic properties of the ZSM-5 can be highly dependent upon the method by which it is manufactured. Silicalite-1 is an all silica framework analogous material to aluminum-containing ZSM-5, both having the (MFI) framework.

As with all synthesis of zeolites, there are various precursors, reagents and utilities (including utility water) used in certain compositional ratios to produce the desired framework. Concomitantly, within a typical refinery, there are by-product streams that must be treated or otherwise disposed of. One of these is a by-product stream from the mercaptan oxidation process, commonly referred to as the MEROX process, which has long been employed for the removal of the generally foul smelling mercaptans found in many hydrocarbon streams and was introduced in the refining industry over fifty years ago. Because of regulatory requirements for the reduction of the sulfur content of fuels for environmental reasons, refineries have been, and continue to be faced with the disposal of large volumes of sulfur-containing by-products. Disulfide oil (DSO) compounds are produced as a by-product of the MEROX process, in which the mercaptans are removed from any of a variety of petroleum streams including liquefied petroleum gas, naphtha, and other hydrocarbon fractions. It is commonly referred to as a “sweetening process” because it removes the sour or foul smelling mercaptans present in crude petroleum. The term “DSO” is used for convenience in this description and in the claims, and will be understood to include the mixture of disulfide oils produced as by-products of the mercaptan oxidation process. Examples of DSO include dimethyldisulfide, diethyldisulfide, and methylethyldisulfide, along with higher molecular weight DSO compounds if a feedstock contains higher boiling point hydrocarbons.

The by-product DSO compounds produced by the MEROX unit can be processed and/or disposed of during the operation of various other refinery units. For example, DSO can be added to the fuel oil pool at the expense of a resulting higher sulfur content of the pool and vapor pressure. DSO can be processed in a hydrotreating/hydrocracking unit at the expense of higher hydrogen consumption. DSO also has an unpleasant foul or sour smell, which is somewhat less prevalent because of its relatively lower vapor pressure at ambient temperature; however, problems exist in the handling of this oil.

Commonly owned U.S. Pat. No. 10,807,947 which is incorporated by reference herein in its entirety discloses a controlled catalytic oxidation of MEROX process by-products DSO. The resulting oxidized material is referred to as oxidized disulfide oil (ODSO). As disclosed in U.S. Pat. No. 10,807,947, the by-product DSO compounds from the mercaptan oxidation process can be oxidized, preferably in the presence of a catalyst. The oxidation reaction products constitute an abundant source of ODSO compounds, sulfoxides, sulfonates, sulfinates and sulfones.

The ODSO stream so-produced contains ODSO compounds as disclosed in U.S. Pat. Nos. 10,781,168 and 11,111,212 as compositions (such as a solvent), in U.S. Pat. No. 10,793,782 as an aromatics extraction solvent, and in U.S. Pat. No. 10,927,318 as a lubricity additive, all of which are incorporated by reference herein in their entireties. In the event that a refiner has produced or has on hand an amount of DSO compounds that is in excess of foreseeable needs for these or other uses, the refiner may wish to dispose of the DSO compounds in order to clear a storage vessel and/or eliminate the product from inventory for tax reasons.

Thus, there is a clear and long-standing need to provide an efficient and economical process for the treatment of DSO by-products and their derivatives to effect and modify their properties in order to facilitate and simplify their environmentally acceptable disposal, and to utilize the resultant modified products in an economically and environmentally friendly manner such as in the synthesis in new materials, and thereby enhance the value of this class of by-products to the refiner.

### SUMMARY OF THE DISCLOSURE

Methods are provided for hydrothermal synthesis of b-oriented MFI zeolite. The method generally comprises forming a solution of precursors and reagents in effective ratios for a b-oriented MFI zeolite including a fluoride-containing mineralizer, and water-soluble oxidized disulfide oil. The solution is hydrothermally treated under effective conditions and for an effective time to synthesize b-oriented MFI zeolite.

In embodiments herein, a method for synthesis of b-oriented MFI zeolite comprises: forming a homogeneous aqueous mixture of precursors and reagents effective for synthesis of MFI zeolite, including a fluoride-containing mineralizer, and water-soluble ODSO; and heating the mixture under conditions and for a time effective to form a precipitate suspended in a supernatant, wherein the precipitate comprises b-oriented MFI zeolite. In certain embodiments, the b-oriented MFI zeolite is a pure silica zeolite.

In embodiments herein, a method to induce b-orientation in MFI zeolites is provided by using oxidized disulfide oil (ODSO) as a sol-gel component in the presence of a fluoride anion to induce b-orientation in MFI zeolites. In certain embodiments the sol-gel also comprises a silica source, an organic template and optionally an aluminum source. In certain embodiments the zeolite is Silicalite-1 having the MFI structure. In certain embodiments the zeolite is ZSM-5having the MFI structure. In certain embodiments the ZSM-5 is a high-silica version. In certain embodiments Silicalite-1 (MFI) converts to b-oriented Silicalite-1 (MFI) in the presence of ODSO.

In certain embodiments, the fluoride-containing mineralizer is a compound that yields F⁻. In certain embodiments the fluoride-containing mineralizer is a fluoride salt. In certain embodiments the fluoride-containing mineralizer is selected from the group consisting of HF, NH₄F, NH₄HF₂, BF₃, NaF, KF, F₂, CHF₃, and combinations comprising two or more of the foregoing.

In certain embodiments, the precursors and reagents comprise a silica source, an optional alumina source, and one of an optional structure directing agent or an optional seed material. In certain embodiments, wherein the fluoride-containing mineralizer and the silica source are provided at a silicon to fluoride ratio (Si/F⁻) (mol./mol.) in the range of about 0.25-20, 0.5-20, 1-20, 5-20, 10-20, 15-20, 0.25-10, 0.5-10, 1-10, 5-20, 0.25-5, 0.5-5, 1-5, 0.25-4, 0.5-4, or 1-4. In certain embodiments, an amount of water-soluble ODSO is based on a ratio of ODSO to F⁻ (wt./wt.) of about 4.3-8.2, 4.3-5.6, 4.3-4.6 or 4.6-5.6. In certain embodiments, the water-soluble ODSO is provide in a pH-modified water-soluble ODSO composition comprising a composition of water-soluble ODSO and alkaline agent having an approximately neutral pH, and wherein an amount of the water-soluble ODSO is based on a ratio of pH-modified water-soluble ODSO to F⁻ (wt./wt.) of about 9.3-15.4 or 9.3-12.4%.

In certain embodiments, the precursors and reagents comprise a structure directing agent including one or more of quaternary ammonium cation compounds paired with an anion. In certain embodiments, the quaternary ammonium cation is selected from the group consisting of tetramethylammonium (TMA), tetraethylammonium (TEA), tetrapropylammonium (TPA), tetrabutylammonium (TBA) and cetyltrimethylammonium (CTA). In certain embodiments, the anion is selected from the group constating of a hydroxide anion, a bromide anion and an iodide anion.

In certain embodiments, the ODSO is derived from oxidation of disulfide oil compounds present in an effluent refinery hydrocarbon stream recovered following catalytic oxidation of mercaptans present in a mercaptan-containing hydrocarbon stream. In certain embodiments, ODSO comprises one or more ODSO compounds having 3 or more oxygen atoms, and/or wherein ODSO comprises one or more ODSO compounds having 1 to 20 carbon atoms, and/or wherein the ODSO comprises one or more ODSO compounds in a mixture having an average density greater than about 1.0 g/cc, and/or wherein the ODSO comprises one or more ODSO compounds in a mixture having an average boiling point greater than about 80° C.

In certain embodiments: the ODSO comprises 3 or more oxygen atoms and include one or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO-—OR), wherein R and R′ can be the same or different C1-C10 alkyl or C6-C10 aryl; the ODSO comprises 3 or more oxygen atoms and include two or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl; the ODSO comprises 3 or more oxygen atoms and include one or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl; or the ODSO comprises 3 or more oxygen atoms and include two or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl.

In certain embodiments, the b-oriented MFI zeolite has enhanced diffusion with respect to that of a comparative zeolite formed in the absence of ODSO and of approximately equivalent compositional ratio, time and conditions effective for the zeolite. In certain embodiments, the b-oriented MFI zeolite has enhanced permeance and/or throughput with respect to that of a comparative zeolite formed in the absence of ODSO and of approximately equivalent compositional ratio, time and conditions effective for the zeolite. In certain embodiments, the b-oriented MFI zeolite has enhanced selectivity with respect to that of a comparative zeolite formed in the absence of ODSO and of approximately equivalent compositional ratio, time and conditions effective for the zeolite.

Any combinations of the various embodiments and implementations disclosed herein can be used. These and other aspects and features can be appreciated from the following description of certain embodiments and the accompanying drawings and claims.

### BRIEF DESCRIPTION OF THE DRAWINGS

FIG. 1A shows a simulated x-ray diffraction pattern of Silicalite-1 (MFI).

FIG. 1B is a schematic diagram of the MFI zeolite structure viewed along the direction.

FIG. 1C shows a simulated x-ray diffraction pattern of a b-oriented MFI zeolite.

FIG. 2 is a simplified schematic diagram of a generalized version of a conventional mercaptan oxidation or MEROX process for the liquid-liquid extraction of a mercaptan containing hydrocarbon stream.

FIG. 3 is a simplified schematic diagram of a generalized version of an enhanced mercaptan oxidation or E-MEROX process.

FIG. 4A is the experimental ¹H-NMR spectrum of the polar, water-soluble ODSO fraction

used in an example herein.

FIG. 4B is the experimental ¹³C-DEPT-135-NMR spectrum of the polar, water-soluble ODSO fraction used in an example herein.

FIG. 5 are the x-ray diffraction patterns of the as-made materials synthesized in the examples herein.

FIG. 6 are the x-ray diffraction patterns of the calcined materials synthesized in the examples herein.

FIG. 7 plots the phase transition of the synthesized products as a function of an amount of ODSO.

FIG. 8A is the experimental ¹H-NMR spectrum of a neutralized water-soluble ODSO fraction in an example herein.

FIG. 8B is the experimental ¹³C-DEPT-135-NMR spectrum of a neutralized water-soluble ODSO fraction in an example herein.

FIG. 8C is a neutralization curve of water-soluble ODSO as a function of the quantity of alkaline agent in an example herein.

FIG. 9 are x-ray diffraction patterns of materials synthesized in examples herein including those with a neutralized ODSO composition.

FIG. 10 plots the phase transition of materials synthesized in examples including those with a neutralized ODSO composition, as a function of an amount of ODSO or neutralized ODSO composition.

### DETAILED DESCRIPTION OF CERTAIN EMBODIMENTS OF THE DISCLOSURE

Methods are provided for hydrothermal synthesis of b-oriented MFI zeolite. In certain embodiments the method is carried out using a solution of precursors and reagents effective for synthesis of MFI zeolite, including a fluoride-containing mineralizer, and water-soluble ODSO. The solution is hydrothermally treated under effective conditions and for an effective time to synthesize a b-oriented MFI zeolite. The resulting b-oriented MFI zeolite has enhanced diffusion than that of “conventional” MFI zeolite framework. The b-oriented MFI zeolites are useful as zeolite membranes.

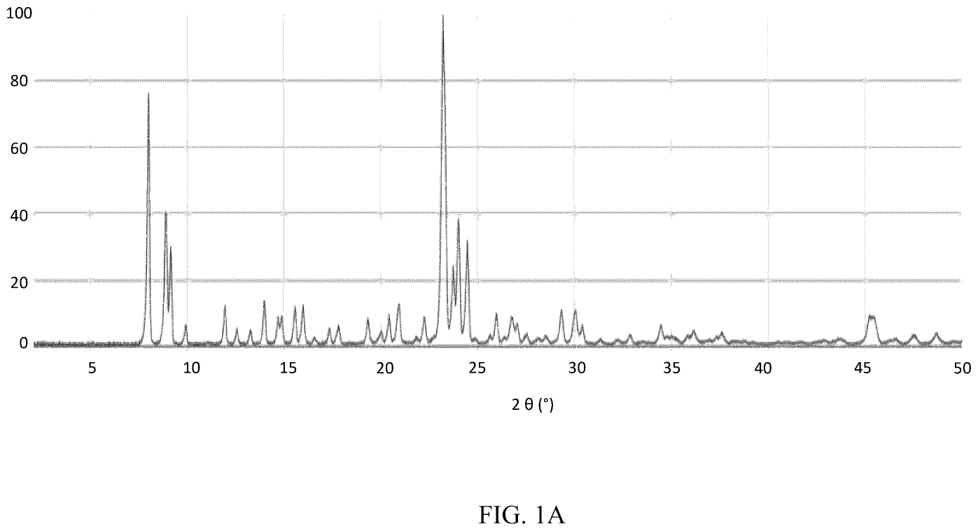

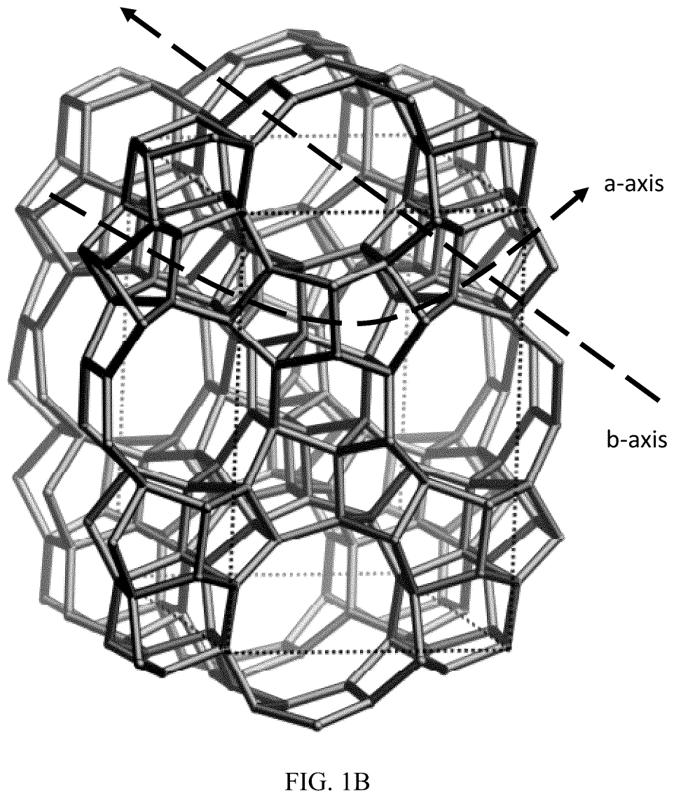

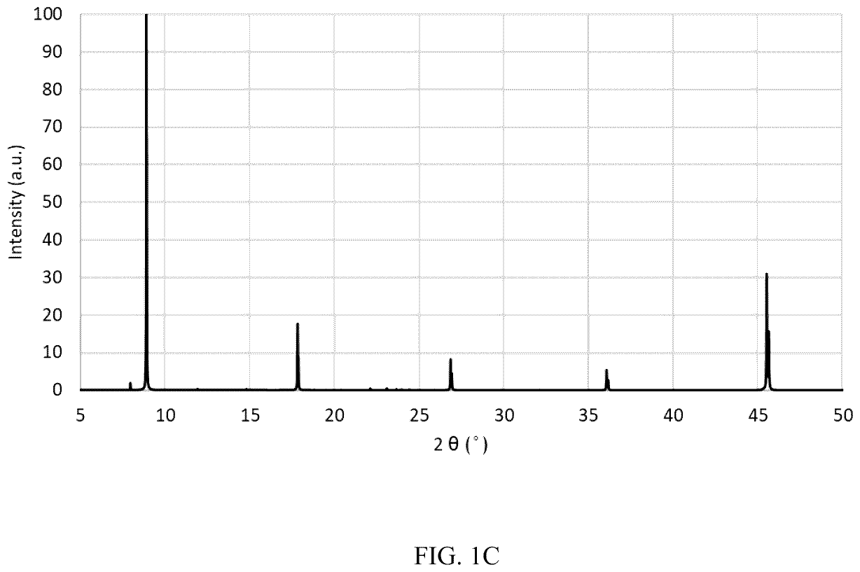

ZSM-5 zeolites have the characteristics listed in Table 1 below (Olson, David H., George T. Kokotailo, Stephen L. Lawton and Walter M. Meier. “Crystal Structure and Structure-Related Properties Of ZSM-5.” J. Phys. Chem. 1981, 85, 15, 2238-2243). A person skilled in the art will recognize that unit cell parameters can vary slightly depending on framework composition such as the silica-to-alumina ratio (SAR). Silicalite-1 is an all silica framework analogous material to aluminum-containing ZSM-5, both having the MFI framework. However, Silicalite-1 is ideally hydrophobic as a result of the absence of acidic A1 sites. Structural silanol defects (Si—OH) may allow for a degree of water adsorption. b-oriented MFI zeolite is a specific sub-type, which is useful as a zeolite thin film. Zeolite thin films are considered attractive as low dielectric constant materials, corrosion-resistant coatings, catalytic membrane reactors, gas/liquid separation media, chemical sensors and optical materials. FIG. 1A shows a simulated x-ray diffraction pattern of Silicalite-1 (MFI).

FIG. 1B, which is adapted from the ‘Atlas of Zeolite Framework Types’ 6th Revised Edition, published on behalf of the Structure Commission of the International Zeolite Association by Elsevier, schematically depicts a framework of b-oriented MFI zeolite. Crystal growth is in the a-c plane with the b vector normal to the a-c plane, that is, platelet morphology is obtained with the thickness of the crystal along the b-axis significantly reduced compared with the a- and c-axes. The MFI structure possesses straight channels when viewed along the [010] direction (10-member-ring having 5.6×5.3 Å dimensions), along the b-axis, and sinusoidal channels when viewed along the [100] direction (10-member-ring having 5.5×5.1 Å dimensions), along the a-axis. With enhanced mass transfer along the b-axis, these pores in b-oriented MFI zeolite are thus orthogonal to the surface of the platelet, which limits diffusion, and as such b-oriented MFI zeolite is useful as a zeolite thin film. The pores of the MFI crystal are orthogonal to the surface (a-c plane). Such pores are expected to limit diffusion constraints. FIG. 1C shows a simulated x-ray diffraction pattern of a b-oriented MFI zeolite, characterized by five diffraction peaks at 8.89°,17.8°, 26.82°, 36.06° and 45.46°, attributed to the (020), (040), (060), (080), and (0100) faces of MFI zeolite.

In embodiments herein, the presence of ODSO and the fluoride anion from the fluoride-containing mineralizer result in growth of the zeolite having an MFI structure in the a-c plane with limited growth in the b-plane. In certain embodiments, the resulting b-oriented MFI zeolite synthesized herein has an enhanced permeance (throughput) and selectivity of separation than that of other MFI zeolites. In certain embodiments, the b-oriented MFI zeolite synthesized herein is a b-oriented Silicalite-1. In certain embodiments, the b-oriented MFI zeolite synthesized herein is a b-oriented ZSM-5. In certain embodiments, the b-oriented MFI zeolite synthesized herein is a b-oriented high-silica ZSM-5.

In the methods herein, water-soluble ODSO is used as a component in the synthesis of b-oriented MFI zeolite along with precursors and reagents for synthesizing MFI zeolite such as Silicalate-1, including a fluoride-containing mineralizer. In certain embodiments methods herein reduce the amount of utility or free water required for synthesizing b-oriented MFI zeolite. In certain embodiments, selection and ratios of precursors and reagents effective for synthesis of MFI zeolite such as Silicalate-1 are known and are formed as a homogeneous aqueous solution. In embodiments herein, synthesis of b-oriented MFI zeolite includes in its sol-gel water-soluble ODSO. In embodiments herein, synthesis of b-oriented MFI zeolite includes water-soluble ODSO that contributes a portion of requisite water for the sol-gel.

In embodiments of a method herein, precursors and reagents for synthesis of MFI zeolite generally comprise a silica source, an optional alumina source, a fluoride-containing mineralizer, an optional structure directing agent and an optional seed material. In the methods herein, water soluble ODSO is added as an additional component together with the precursors and reagents for zeolite synthesis.

In embodiments of a method herein, precursors and reagents for hydrothermal synthesis of aluminosilicate zeolite generally comprise a silica source, an alumina source, a fluoride-containing mineralizer, and one or both of a structure directing agent and a seed material. In the methods herein, water soluble ODSO is added as an additional component together with the precursors and reagents for zeolite synthesis.

In embodiments of the method herein, precursors and reagents for hydrothermal synthesis of a PSZ form of MFI zeolite (such as Silicalite-1) generally comprise a silica source, a fluoride-containing mineralizer, and one or both of a structure directing agent and a seed material. In the methods herein, water soluble ODSO is added as an additional component together with the precursors and reagents for zeolite synthesis.

In the syntheses of MFI zeolites including PSZs, it is typically necessary to use at least one of a structure directing agent, pore filling agents or seed material. In certain embodiments, a structure directing agent is used and pore filling agents and seed material is not used. In certain embodiments, a seed material is used and a structure directing agent is not required. In the above embodiments in which a structure directing agent is used, the selection and amount of structure directing agent influences the target type of MFI zeolite structure to be formed. Effective structure directing agents that be added include known or developed structure directing agents for a particular type of MFI. Preparation of MFIs with structure directing agents enables direction of the structure, and filling of the pores/channels in the as-made products. In certain embodiments pore filling agents are used with structure directing agents as additional material to fill pores and maintain pore stability and structural integrity. In addition, in embodiments herein structure directing agents include a cation and an anion, wherein the anion is a hydroxide and contributes as a mineralizer for the MFI syntheses. In additional embodiments, a mineralizer from other sources including a fluoride-containing mineralizer can be provided together with a hydroxide form of a structure directing agent. In some embodiments another source of hydroxide anions is a silica source in optional embodiments using such a silica source, for instance silicon hydroxide or sodium silicate.

In certain embodiments, the zeolite is a PSZ, wherein precursors and reagents effective for PSZ syntheses comprise a silica source, a fluoride-containing mineralizer, and one or both of a structure directing agent and a seed material. For example, in certain known synthesis a structure directing agent is used and a seed material is optional, and in further embodiments a seed material is used and a structure directing agent is optional. The present disclosure is applicable to a PSZ that is has MFI framework, such as silicalite, Silicalite-1, or ZSM-5. For instance, as disclosed in the herein examples, Silicalite-1 is synthesized with an MFI framework. Note that while both Silicalite-1 and ZSM-5 possess MFI frameworks, ZSM-5 is an aluminosilicate whereas Silicalite-1 is a pure silica analogue.

In the process herein, growth of the zeolite having an MFI structure, in the presence of ODSO and fluoride anions, is in the a-c plane with limited growth in the b-plane. In certain embodiments, the pores of the MFI crystal are orthogonal to the surface (a-c plane).

An effective amount of water for the aqueous environment and as a solvent during the sol-gel syntheses of porous crystalline materials is provided from one or more water sources, including utility water (also referred to as free water) that is added to form the homogeneous aqueous mixture, or water from one or more precursors and reagents, for example: a water-containing silica source such as colloidal silica in embodiments of syntheses in which a silica source is used as a precursor; an aqueous mixture of an alumina source in embodiments of syntheses in which an alumina source is used as a precursor; an aqueous mixture of a structure directing agent in embodiments of syntheses in which a structure directing agent is used as a precursor and/or reagent; an aqueous mixture of a seed material in embodiments of syntheses in which a seed material is used; and/or an aqueous mixture of a fluoride-containing mineralizer. In embodiments herein, water soluble ODSO (neat or from another source such as a pH-modified water-soluble ODSO composition or from a supernatant derived from a synthesis using ODSO) replaces a certain amount of the water used for the aqueous environment and as a solvent during the sol-gel syntheses.

These mixture components are added with water to the reaction vessel prior to heating. Typically, water allows for adequate mixing to realize a more homogeneous distribution of the sol-gel components, which ultimately produces a more desirable product because each crystal is more closely matched in properties to the next crystal. Insufficient mixing could result in undesirable “pockets” of highly concentrated sol-gel components, and this may lead to impurities in the form of different structural phases or morphologies. Water also determines the yield per volume. In the descriptions that follow, it is understood that water is a component of homogeneous aqueous mixtures from one or more of the sources of water. In the methods herein a portion of an effective amount of water required for sol-gel synthesis is replaced with water soluble ODSO. In certain embodiments, the water that is replaced with the water soluble ODSO can be all or a portion of the free water that would typically be added.

In the above embodiments in which a silica source is used, the silica source can comprise, without limitation, one or more of silicates including sodium silicate (water glass), rice husk, fumed silica, precipitated silica, colloidal silica, silica gels, other zeolites, dealuminated zeolites, and silicon hydroxides and alkoxides. Silica sources resulting in a high relative yield are preferred. For instance, suitable materials as silica sources include fumed silica commercially available from Cabot and colloidal silica (LUDOX commercially available from Cabot).

In the above embodiments in which an alumina source is used, the aluminum source can comprise, without limitation, one or more of aluminates, alumina, other zeolites, aluminum colloids, boehmites, pseudo-boehmites, aluminum salts such as aluminum nitrate, aluminum sulfate and alumina chloride, aluminum hydroxides and alkoxides, aluminum wire and alumina gels. For example, suitable materials as aluminum sources include commercially available materials including for instance high purity aluminas (CERALOX commercially available from Sasol) and alumina hydrates (PURAL and CAPITAL commercially available from Sasol), boehmites (DISPERSAL and DISPAL commercially available from Sasol), and silica-alumina hydrates (SIRAL commercially available from Sasol) and the corresponding oxides (SIRALOX commercially available from Sasol).

In the above embodiments in which a structure directing agent is used, the structure directing agent selected to influence the target type of zeolite structure to be formed. Effective structure directing agents that can optionally be added include known or developed structure directing agents for a particular type or sub-type of zeolite. Effective structure directing agents for MFI zeolites include one or more of quaternary ammonium cation compounds (including one or more of tetramethylammonium (TMA) cation compounds, tetraethylammonium (TEA) cation compounds, tetrapropylammonium (TPA) cation compounds, tetrabutylammonium (TBA) cation compounds, cetyltrimethylammonium (CTA) cation compounds; the cation can be paired with one or more of a hydroxide anion (for example, TPAOH or CTAOH), a bromide anion (for example, TPAB or CTAB), or an iodide anion. In embodiments in which the target zeolite structures are MFI zeolites, including ZSM-5, structure directing agents include but are not limited to one or more of: those identified above for MFI zeolites; bifunctional dicationic molecules containing a long aliphatic chain (for example C₂₂H₄₅—N⁺(CH₃)₂—C₆H₁₂—N⁺(CH₃)₂—C₆H₁₃, denoted C₂₂₋₆₋₆, C₂₂H₄₅—N⁺(CH₃)₂—C₆H₁₂—N⁺(CH₃)₂—C₃H₇, denoted C₂₂₋₆₋₃, or a poly(ethylene glycol)); dual-porogenic surfactants; silylated polyethylenimine polymers; amphiphilic organosilanes; or hydrophilic cationic polyelectroyltes/polymers such as poly(diallyldimethylammonium chloride) (PDADMAC).

The disclosed process for synthesizing MFI zeolite as disclosed herein can occur in the absence or presence of seed materials comprising zeolite structures of the same or similar crystalline framework structure as the target zeolite framework for production. For example, suitable seed materials include ZSM-5 (MFI), ZSM-8 (MFI), ZSM-11 (MEL) and Silicalite-1 (MFI). Functions of the seeds can include, but are not limited to: supporting growth on the surface of the seed, that is, where crystallization does not undergo nucleation but rather crystal growth is directly on the surface of the seed; the parent gel and seed share common larger composite building units; the parent gel and seed share common smaller units, for instance 4 member rings; seeds that undergo partial dissolution to provide a surface for crystal growth of a zeolite; crystallization occurs through a “core-shell” mechanism with the seed acting as a core and the target material grows on the surface; and/or where the seeds partially dissolve providing essential building units that can orientate crystallization of the zeolite or other crystalline structure. In embodiments where zeolites comprise Silicalite-1, precursors and reagents effective for the crystalline material comprise a silica source, an optional alumina source, a mineralizer, a structure directing agent an optional seed material.

As described herein, reagents in the method herein comprise a fluoride-containing mineralizer. Typical syntheses of porous crystalline materials typically use a mineralizer, including a hydroxide or fluoride anion. In certain syntheses hydroxide anion mineralizers can result in silanol clusters which lead to structural defects in the framework, whereas fluoride anion mineralizers minimize or eliminate such clusters and promote reduced defect or defect-free structures. For example, while not wishing to be bound by theory, in the presence of a fluoride-based mineralizer solubility of silica is enhanced at pH values approaching neutral. In hydrothermal syntheses using basic mineralizers such as hydroxides, pH levels of the sol-gel may be in the range of about 13-14; when using a fluoride-containing mineralizer, the pH of the sol-gel in certain embodiments is in the range of about 8-7.

Furthermore, use of fluoride anion mineralizers promotes Si—O—Si bonds, which is effective for high silica all silica zeolites. In certain embodiments use of fluoride anion mineralizers more effectively promotes synthesis of frameworks possessing double-four rings as compared to use of hydroxide anion mineralizers. In certain embodiments the use of fluoride anion mineralizers rather than hydroxide anion mineralizers yields fewer competing phases. In certain embodiments the use of fluoride anion mineralizers rather than hydroxide anion mineralizers increases the ability to synthesize NH₄-form of porous crystalline materials thereby avoiding Na⁺ ion-exchange. In certain embodiments the use of fluoride anion mineralizers rather than hydroxide anion mineralizers facilitates syntheses at close to neutral pH. In certain embodiments the use of fluoride anion mineralizers rather than hydroxide anion mineralizers facilitates syntheses at close to neutral pH and thereby increases solubility of functional elements to be incorporated (for example, Ti, Ga, or B, that may otherwise have solubility issues under highly alkaline conditions. In certain embodiments the use of fluoride anion mineralizers rather than hydroxide anion mineralizers increases hydrothermal stability during steam treatment at high temperatures, for example in MFI zeolites prepared in the presence of hydroxide media; while not wishing to be bound by theory the fewer structural defects in the fluoride analogue are the reason for improved hydrothermal stability, since silanol groups (defect sites) have previously been identified as the site for which hydrolysis of the zeolite framework occurs.

The fluoride-containing mineralizer used in the methods herein provides a source of fluoride anion. In certain embodiments the fluoride-containing mineralizer is a compound that yields F⁻. In certain embodiments the fluoride-containing mineralizer is a fluoride salt. In certain embodiments the fluoride-containing mineralizer is selected from the group consisting of HF, NH₄F, NH₄HF₂, BF₃, NaF, KF, F₂, CHF₃, and combinations comprising two or more of the foregoing.

An effective quantity of the fluoride-containing mineralizer can be measured based on, for example, molar ratio relative to one or more of the precursors in the selected synthesis system. In certain embodiments, the porous crystalline material includes silicon in its framework (thus precursors comprise a silica source) and effective quantity of the fluoride-containing mineralizer can be measured based on a silicon to fluoride ratio (Si/F⁻) (mol./mol.) In certain embodiments, the porous crystalline material includes silicon in the framework, for example a zeolite, and an effective Si/F⁻ molar ratio for the sol-gel is, for instance, in the range of about 0.25-20, 0.5-20, 1-20, 5-20, 10-20, 15-20, 0.25-10, 0.5-10, 1-10, 5-20, 0.25-5, 0.5-5, 1-5, 0.25-4, 0.5-4, or 1-4. In certain embodiments, the porous crystalline material includes aluminum in its framework (for example aluminosilicate zeolites, SAPO, AlPO or MAPO, thus precursors comprise an aluminum source) and effective quantity of the fluoride-containing mineralizer can be measured based on an aluminum to fluoride ratio (Al/F⁻) (mol./mol.). In certain embodiments, the porous crystalline material includes aluminum in the framework, and an effective Al/F⁻ molar ratio for the sol-gel is, for instance, in the range of about 0.025-1, 0.025-0.8, 0.025-0.6, 0.025-0.4, 0.025-0.2, 0.05-1, 0.05-0.8, 0.05-0.6, 0.05-0.4, 0.05-0.2, 0.075-1, 0.075-0.8, 0.075-0.6, 0.075-0.4, or 0.075-0.2.

In certain embodiments, the reagents include a structure directing agent and effective quantity of the fluoride-containing mineralizer can be measured based on a structure directing agent to fluoride ratio (structure directing agent/F⁻) (mol./mol.) In certain embodiments, the reagents include a structure directing agent and an effective structure directing agent/F⁻ molar ratio for the sol-gel is, for instance, in the range of about 0.05-4.0, 0.05-3.0, 0.05-2.0, 0.05-1.0, 0.05-0.5, 0.5-4.0, 0.5-3.0, 0.5-2.0, 0.5-1.0, 1.0-4.0, 1.0-3.0, or 1.0-2.0.

In an embodiment of a method of synthesizing zeolite, effective amounts and proportions of precursors and reagents are formed together with water-soluble ODSO as a homogeneous aqueous mixture, including a water source, an optional alumina source, a silica source, a fluoride-containing mineralizer, an optional structure directing agent and an optional seed material. An effective amount of a water-soluble ODSO component is used as an additional component in the syntheses processes herein.

In certain embodiments herein, synthesis of b-oriented MFI zeolites includes a water-soluble ODSO composition that contributes a portion of requisite aqueous medium and/or solvent for the sol-gel, for example, using a pH-modified water-soluble ODSO composition comprising an aqueous mixture of one or more water-soluble ODSO compounds and an effective amount of an alkaline agent as disclosed in co-pending and commonly owned US Patent Application Ser. Numbers (filed Jun. 27, 2022): Ser. No. 17/850,158 entitled “pH-Modified Water-Soluble Oxidized Disulfide Oil Compositions;” Ser. No. 17/850,219 (U.S. Pat. No. 11,649,405) entitled “Methods of Modifying pH of Water-Soluble Oxidized Disulfide Oil;” and Ser. No. 17/850,115 entitled “Method of Zeolite Synthesis Including pH-Modified Water-Soluble Oxidized Disulfide Oil Compositions;” each of which are incorporated by reference herein in their entireties.

In certain embodiments herein, synthesis of b-oriented MFI zeolites includes a water-soluble ODSO composition that contributes a portion of requisite aqueous medium and/or solvent for the sol-gel, for example, using supernatant from a prior synthesis that utilized water-soluble ODSO as a component in place of a certain amount of utility water, for example as disclosed in co-pending and commonly owned U.S. patent application Ser. No. 17/850,285 filed on Jun. 27, 2022, entitled “Method of Synthesizing Materials Integrating Supernatant Recycle” which is incorporated by reference herein in its entirety.

In the herein methods of synthesizing porous crystalline material, effective amounts and proportions of precursors and reagents a fluoride-containing mineralizer are formed together with a water-soluble ODSO component as a homogeneous aqueous mixture. The components are mixed for an effective time and under conditions suitable to form the homogeneous aqueous mixture. The chronological sequence of mixing can vary, with the objective being a highly homogenous distribution of the components in an aqueous mixture. The homogeneous aqueous mixture is heated under conditions and for a time effective to form a precipitate (product including porous crystalline material) suspended in a supernatant (mother liquor). The precipitate is recovered, for example by filtration, washing and drying. In certain embodiments the recovered precipitate is calcined at a suitable temperature, temperature ramp rate and for a suitable period of time.

The mixing steps typically occur at ambient temperature and pressure (for instance about 20° C. and about 1 standard atmosphere), for a time is sufficient to realize a homogeneous distribution of the components. In certain embodiments the sol-gel can be aged before being subjected to subsequent hydrothermal treatment, for example for a period of about 0-72, 0-48, 0-24, 0-6, 0.5-72, 0.5-48, 0.5-24, 6-72, 6-48 or 6-24 hours. Hydrothermal treatment is then carried out at a temperature in the range of about 90-220, 90-200, 90-180, 90-160, 100-220, 100-200, 100-180, 100-160, 120-220, 120-200, 120-180, 120-160, 140-220 or 140-200° C. and at atmospheric or autogenous pressure (from the sol-gel or from the sol-gel plus an addition of a gas purge into the vessel prior to heating), and for a time period within the range of about 0.1-14, 0.2-14, 0.1-12, 0.2-12, 0.1-10, 0.2-10, 0.1-7, 0.2-7, 0.1-6, 0.2-6, 0.1-5 or 0.2-5 days, to ensure crystallization and formation of a zeolite gel. As is known, these time periods and temperatures can vary depending on the desired zeolite or other crystalline material framework to be produced.

The products are washed, for example with water at a suitable quantity, for example at about twice the volume of the sol-gel solution. The wash can be at a temperature of from about −63 to 80° C. at atmospheric, vacuum or under pressure. The wash can continue until the pH of the filtrate approaches about 5-9, 5-7, or 7-9. The solids are recovered by filtration, for instance, using known techniques such as centrifugation, gravity, vacuum filtration, filter press, or rotary drums, and dried, for example at a temperature of up to about 110 or 150° C.

In certain embodiments, recovered precipitate is calcined at a suitable temperature, temperature ramp rate and for a suitable period of time. In certain embodiments, calcining is carried out to increase porosity. In certain embodiments, calcining is carried out to remove all or a portion of structure directing agent components that remain in the precipitate to realize porous zeolite. In optional embodiments in which calcination is carried out on zeolite produce, conditions for calcination can include temperatures in the range of about 350-1000, 350-700, 350-685, 350-650, 450-1000, 450-700, 450-685, 450-650, 500-1000, 500-700, 500-685 or 500-650° C., atmospheric pressure, and a time period of about 3-24, 3-18, 6-24 or 6-18 hours. Calcining can occur with ramp rates in the range of about 0.1-10, 0.1-5, 0.1-3, 1-10, 1-5 or 1-3° C. per minute. In certain embodiments calcination can have a first step ramping to a temperature of between about 100-150° C. with a holding time of from about 2-24 hours (at ramp rates of from about 0.1-5, 0.1-3, 1-5 or 1-3° C. per min) before increasing to a higher temperature with a final holding time in the range of about 2-24 hours.

It is to be appreciated by those skilled in the art that in certain embodiments effective baseline compositional ratios for synthesis of MFI zeolites such as Silicalate-1 as disclosed herein can be determined by empirical data, for instance summarized as phase boundary diagrams or other methodologies as is known in material synthesis. In embodiments herein, baseline compositional ratios and conditions are effective, in the absence of water soluble ODSO or in lesser amounts of water soluble ODSO, for synthesis of MFI zeolites that are not characterized by b-orientation, and according to embodiments of the process herein, inclusion of water soluble ODSO in a suitable amount results in shifting the material to b-orientation.

In certain embodiments, effective ratios of precursors and reagents for production of zeolites herein are within those known to produce templated aluminosilicate zeolites or PSZs and can be determined by those of ordinary skill in the art. For example, effective amounts of silica and alumina precursors are provided to produce synthesized MFI zeolite having a silica-to-alumina ratio (SAR) in the range of about 10-1500, 20-1500, 0-1000, 10-1000, 20-1000, 0-500, 10-500, 20-500, 25-1500, 25-1000, 25-500, 50-1500, 50-1000, 50-500, 100-1500, 100-1000 or 100-500. In embodiments in which a structure directing agent is used, an effective amount includes a molar ratio (normalized to 1 mole of Al₂O₃) in the range of about 0.1-75, 0.1-50, 0.1-30, 0.1-20, 0.1-15, 1-75, 1-50, 1-30, 1-20, 1-15, 2.5-75, 2.5-50, 2.5-30, 5-75, 5-50 or 5-30.

In certain embodiments, baseline compositional ratios of the aqueous composition used to produce zeolites herein include (on a molar basis): SiO₂/Al₂O₃ of about 10-1500; OH⁻/SiO₂ of about 0.05-3; R/SiO₂ of about 0-1.5; alkali metal cation/SiO₂ of about 0.075-1.5; and H₂O/SiO₂ of about 5-120; wherein R is the structure directing agent, and a level of 0 represents absence of the structure directing agent.

In certain embodiments in which PSZs are produced, effective baseline ratios can be determined by empirical data, for instance summarized as phase boundary diagrams or other methodologies as is known in material synthesis. In certain embodiments, baseline compositional ratios of the aqueous composition used to produce PSZs herein include (on a molar basis): Si/F⁻ of about 0.25-20, 0.5-20, 1-20, 5-20, 10-20, 15-20, 0.25-10, 0.5-10, 1-10, 5-20, 0.25-5, 0.5-5, 1-5, 0.25-4, 0.5-4, or 1-4; R/SiO₂ of about 0-1.0, 0.01-1.0, 0.05-1.0, 0-0.5, 0.01-0.5 or 0.05-0.5; H₂O/SiO₂ of about 5-80, 10-80 or 20-80; wherein R is the structure directing agent, and a level of 0 represents absence of the structure directing agent. The seed component may also be present based on a mass percentage of total silica in the system, for example in the range of about 0-15, 0.1-15, 0-10, 0.1-10, 0-7.5, 0.1-7.5, 0-5 or 0.1-5 percent by mass based on the mass of silica. It is appreciated by those skilled in the art that these molar composition ratios can be expressed on a mass or a molar basis.

The present disclosure includes one or more water-soluble ODSO compounds including ODSO compounds that are used as a component in a material synthesis process. The additional components can be a mixture that comprises two or more ODSO compounds. In the description herein, the terms “oxidized disulfide oil”, “ODSO”, “ODSO mixture” and “ODSO compound(s)” may be used interchangeably for convenience. As used herein, the abbreviations of oxidized disulfide oils (“ODSO”) and disulfide oils (“DSO”) will be understood to refer to the singular and plural forms, which may also appear as “DSO compounds” and “ODSO compounds,” and each form may be used interchangeably. In certain instances, a singular ODSO compound may also be referenced.

In embodiments in which pH-modified water-soluble ODSO composition, it is formed as described in in co-pending and commonly owned US Patent Application Serial Numbers (filed Jun. 27, 2022): Ser. No. 17/850,158 entitled “pH-Modified Water-Soluble Oxidized Disulfide Oil Compositions;” Ser. No. 17/850,219 (U.S. Pat. No. 11,649,405) entitled “Methods of Modifying pH of Water-Soluble Oxidized Disulfide Oil;” and Ser. No. 17/850,115 entitled “Method of Zeolite Synthesis Including pH-Modified Water-Soluble Oxidized Disulfide Oil Compositions;” each of which are hereinabove incorporated by reference herein in their entireties. The water-soluble ODSO is an acidic component. The pH-modified water-soluble ODSO composition can be deacidified, neutralized or basified, relative to the initial water-soluble ODSO mixture. For example, to making such as pH-modified water-soluble ODSO composition, a reaction vessel (for example generally selected from one or more of a fixed-bed reactor, an ebullated bed reactor, a slurry bed reactor, a moving bed reactor, a continuous stirred tank reactor, and a tubular reactor) is provide which includes: one or more inlets in fluid communication with a source of, and configured and arranged for receiving, an effective amount of water-soluble ODSO; one or more inlets in fluid communication with a source of, and configured and arranged for receiving, an effective amount of alkaline agent; and one or more outlets for discharging a composition having an increased pH relative to the influent water-soluble ODSO. In addition, gases are discharged, typically as byproduct, and solids can be formed during reaction of water-soluble ODSO and alkaline agent; which can be removed from the system (which can be removed continuously, semi-continuously or in batch). Depending on the amount of alkaline agent used, the pH level of the effluent stream is greater than the pH of the influent water-soluble ODSO, but the ultimate level can vary. In certain embodiments the PH level of the effluent stream is neutral or approximately neutral pH. In certain embodiments the PH level of the effluent stream is deacidified relative to the influent water-soluble ODSO. In certain embodiments the PH level of the effluent stream is basic.

Therefore, as is apparent, a pH-modified water-soluble ODSO composition comprises an alkaline agent that can be a suitable basic component that, when added to the water-soluble ODSO component, results in an increase in the pH value of a resulting solution. Typically, an alkaline agent is provided as an aqueous basic solution, for example having concentrations in the range of about 1-99, 1-70, 1-50, 5-99, 5-70, 5-50, 10-99, 10-70 or 1-50 mass percent of base compounds. In certain embodiments the water-soluble ODSO is provided in an aqueous medium, there is sufficient water to dissolve an alkaline agent provided in anhydrous form.

The amount of alkaline is provided that is sufficient, on a mole to mole basis, to produce a composition of water-soluble ODSO and alkaline agent having a pH value that is greater than the pH value of the initial water-soluble ODSO mixture, in certain embodiments to a pH that is neutral (7) or approximately neutral. It is to be appreciated that this is expressed herein in an embodiment as a mass percent, but that can vary based on factors including but not limited to the specific composition of the ODSO mixture and the concentration and selection of the alkaline agent.

In certain embodiments, an effective amount of the alkaline agent is added produce a composition of water-soluble ODSO and alkaline agent having a pH value that is greater than the pH value of the initial water-soluble ODSO mixture; for example, an effective amount in such embodiments 10-99% of a molar equivalent to number of acid sites of the total water-soluble ODSO. In such a manner, the pH of the produced aqueous solution of water-soluble ODSO and alkaline agent can be tailored to a particular end-use, for instance with a pH curve developed with empirical data for a given water-soluble ODSO composition and a selected alkaline agent.

In certain embodiments, an effective amount of the alkaline agent is added produce a composition of water-soluble ODSO and alkaline agent having a pH value that is neutral or approximately neutral. In certain embodiments, an effective amount of the alkaline agent is added to produce a composition of water-soluble ODSO and alkaline agent having a pH value that is in the range of about 6-8, 6.5-7.5, 6.8-7.2, 6.9-7.1 or 7. For example, an effective amount of alkaline agent used can be such that the hydronium ions in the system must have a concentration between about 10⁻⁶ to 10⁻⁸ molar (M). For instance, for a water-soluble ODSO composition derived from controlled catalytic oxidation of DSO compounds from a MEROX process, the composition of water-soluble ODSO and alkaline agent comprises about 18-19 mass percent of alkaline agent (relative to the mass of the total composition) to attain a pH in the range of about 6-8.

In certain embodiments, an alkaline agent of a pH-modified water-soluble ODSO composition is a base selected from the group consisting of sodium hydroxide, calcium hydroxide, lithium hydroxide, strontium hydroxide, barium hydroxide, potassium hydroxide, cesium hydroxide, rubidium hydroxide, ammonia, ammonium hydroxide, lithium hydroxide, zinc hydroxide, trimethylamine, pyridine, beryllium hydroxide, magnesium hydroxide, and mixtures thereof. In certain embodiments, an alkaline agent of a pH-modified water-soluble ODSO composition is a strong base, for example, selected from the group consisting of sodium hydroxide, calcium hydroxide, lithium hydroxide, strontium hydroxide, barium hydroxide, potassium hydroxide, cesium hydroxide, rubidium hydroxide, and mixtures thereof. In certain embodiments, an alkaline agent of a pH-modified water-soluble ODSO composition herein is a weak base, selected from the group consisting of ammonia, ammonium hydroxide, lithium hydroxide, zinc hydroxide, trimethylamine, pyridine, and mixtures thereof. In certain embodiments, other bases can be used as an alkaline agent in the methods and compositions herein, for example selected from the group consisting of beryllium hydroxide, magnesium hydroxide, and mixtures thereof. In certain embodiments, an alkaline agent in the methods and compositions herein is selected from the group consisting of sodium hydroxide, potassium hydroxide, ammonium hydroxide and mixtures thereof. In certain embodiments, an alkaline agent in the methods and compositions herein is selected from the group consisting of sodium hydroxide, potassium hydroxide, rubidium hydroxide, lithium hydroxide, cesium hydroxide, and mixtures thereof.

A pH-modified water-soluble ODSO composition generally has a pH value greater than that of the initial water-soluble ODSO composition. In certain embodiments a pH-modified water-soluble ODSO composition is neutral or approximately neutral in pH. In certain embodiments a pH-modified water-soluble ODSO composition has an approximately neutral pH, for example in the range of about 6-8, 6.5-7.5, 6.8-7.2, 6.9-7.1 or about 7. In certain embodiments a pH-modified water-soluble ODSO composition comprises deacidified water-soluble ODSO that has an acidic pH that is higher than that of the initial water-soluble ODSO; for example, if the initial water-soluble ODSO has a pH of 1, the deacidified water-soluble ODSO has a pH of about 1.1 or greater, up to about neutral, for example about 1.1-8, 1.1-7.5, 1.1-7.0, 1.1-6.9 or 1.1-6.5. In certain embodiments the composition comprises basified water-soluble ODSO that has a basic pH, for instance greater than about 7, 8, 9 or 10, for example about 7.1-14, 7.5-14 or 8-14. The selection of the pH value of the pH-modified water-soluble ODSO composition depends on the type of material being produced, what components are being replaced as related to conventional synthesis, and other factors.

In certain embodiments, water-soluble ODSO used in a pH-modified water-soluble ODSO composition contains a first weight percent of atomic sulfur, and the pH-modified water-soluble ODSO composition contains a lesser weight percent of atomic sulfur than the first quantity of atomic sulfur. In certain embodiments, the initial water-soluble ODSO used in the pH-modified water-soluble ODSO composition contains a first weight percent of atomic alkali metal, and the pH-modified water-soluble ODSO composition contains a greater weight percent of atomic alkali metal than the first quantity of atomic alkali metal.

The water-soluble ODSO component can be in the form of a neat water-soluble ODSO, as an aqueous water-soluble ODSO solution, as a pH-modified ODSO, and/or a supernatant from a prior synthesis using water-soluble ODSO. An effective amount of water-soluble ODSO is used as an additional component in zeolite synthesis. In certain embodiments a water-soluble ODSO component (neat) is used in place of a certain amount of water. In certain embodiments a water-soluble ODSO component is provided as a pH-modified water-soluble ODSO composition and is used in place of an equivalent amount (on a mass or volume basis) of a certain amount of water (such as utility water) for the homogeneous aqueous mixture. Various factors can contribute to the quantity of pH-modified water-soluble ODSO as an effective amount thereof, including but not limited to the proportions of precursors and reagents including a fluoride-containing mineralizer, and other components such as those of a pH-modified water-soluble ODSO composition or supernatant from a synthesis using water-soluble ODSO.

In certain embodiments, an effective amount water-soluble ODSO is quantified based on an amount of water replaced relative to a baseline compositional ratio or amount of water in the absence of water-soluble ODSO. In certain embodiments, an effective amount of water-soluble ODSO used in the homogeneous aqueous mixture of precursors and reagents including a fluoride-containing mineralizer is quantified based on an amount of water replaced relative to a baseline compositional ratio or amount of total water from all sources in the absence of water-soluble ODSO. For example, in certain embodiments, for synthesis of products comprising b-orientated MFI zeolite, ODSO is added in an amount by mass of ODSO, relative to the total mass of water and ODSO, of about 20-45, 20-40, 20-35, 20-30, 20-25, 23-45, 33-40, 23-35, 23-30% or 23-25%, for instance when using essentially solid precursors and reagents (e.g., 98 wt %) other than water and the water-soluble ODSO. In certain embodiments, for synthesis of products comprising Silicalite-1 (MFI) and b-oriented MFI zeolite, a pH-modified water-soluble ODSO composition (wherein the pH-modified water-soluble ODSO composition is a neutralized water-soluble ODSO composition (e.g., the composition of water-soluble ODSO and alkaline agent comprises about 18-19 mass percent of alkaline agent (relative to the mass of the total composition) to attain an approximately neutral pH in the range of about 6-8)) is added in an amount by mass of the pH-modified water-soluble ODSO composition, relative to the total mass of water and the pH-modified water-soluble ODSO composition, of, for example, about 49.8-83.1 or 49.8-66.4%, for instance when using essentially solid precursors and reagents (e.g., 98 wt %) other than water and the pH-modified water-soluble ODSO composition.

In certain embodiments, an effective amount of ODSO used in the homogeneous aqueous mixture of precursors and reagents including a fluoride-containing mineralizer is quantified based on an amount of water replaced relative to a baseline compositional ratio or amount of free water added in the absence of ODSO. In certain embodiments, for synthesis of products comprising b-orientated MFI zeolite, ODSO is added in an amount by mass of ODSO, relative to the total mass of free water and ODSO, of about 20-45, 20-40, 20-35, 20-30, 20-25, 20-24, 23-45, 23-40, 23-35, 23-30, 23-25, 23-24, 24-45, 24-40, 24-35, 24-30, or 24-25%. In certain embodiments, for synthesis of products comprising Silicalite-1 (MFI) and b-oriented MFI zeolite, a pH-modified water-soluble ODSO composition (wherein the pH-modified water-soluble ODSO composition is a neutralized water-soluble ODSO composition (e.g., the composition of water-soluble ODSO and alkaline agent comprises about 18-19 mass percent of alkaline agent (relative to the mass of the total composition) to attain an approximately neutral pH in the range of about 6-8)) is added in an amount by mass of the pH-modified water-soluble ODSO composition, relative to the total mass of free water and the pH-modified water-soluble ODSO composition, of, for example, about 50-83.3 or 50-66.7%, for instance when using essentially solid precursors and reagents (e.g., 98 wt %) other than water and the pH-modified water-soluble ODSO composition.

In certain embodiments, an effective amount of ODSO used in the homogeneous aqueous mixture of precursors and reagents including a fluoride-containing mineralizer is quantified based on a ratio relative to fluoride anions. In certain embodiments, an amount of ODSO used in the homogeneous aqueous mixture of precursors and reagents including a fluoride-containing mineralizer is quantified based on a ratio of ODSO to F⁻ ratio, on a molar or mass basis. In certain embodiments, for synthesis of products comprising b-orientated MFI zeolite, the amount of ODSO is based on a ratio of ODSO to F⁻ (wt./wt.) of about 4.3-8.2, 4.3-5.6, 4.3-4.6 or 4.6-5.6. In certain embodiments, for synthesis of products comprising Silicalite-1 (MFI) and b-oriented MFI zeolite, the amount of pH-modified water-soluble ODSO composition (wherein the pH-modified water-soluble ODSO composition is a neutralized water-soluble ODSO composition (e.g., the composition of water-soluble ODSO and alkaline agent comprises about 18-19 mass percent of alkaline agent (relative to the mass of the total composition) to attain an approximately neutral pH in the range of about 6-8)) is based on a ratio of pH-modified water-soluble ODSO to F⁻ (wt./wt.) of, for instance, about 9.3-15.4 or 9.3-12.4%.

In certain embodiments, a fluoride-containing mineralizer is NH₄F, and an effective amount of ODSO used in the homogeneous aqueous mixture of precursors and reagents including NH₄F is quantified based on a ratio relative to the mass of the NH₄F. In certain embodiments, for synthesis of products comprising b-orientated MFI zeolite, the amount of ODSO is based on a ratio of ODSO to NH₄F (wt./wt.) about 2.2-4.2, 2.2-2.4 or 2.3-4.2. In certain embodiments, for synthesis of products comprising Silicalite-1 (MFI) and b-oriented MFI zeolite, the amount of pH-modified water-soluble ODSO composition (wherein the pH-modified water-soluble ODSO composition is a neutralized water-soluble ODSO composition (e.g., the composition of water-soluble ODSO and alkaline agent comprises about 18-19 mass percent of alkaline agent (relative to the mass of the total composition) to attain an approximately neutral pH in the range of about 6-8)) is based on a ratio of pH-modified water-soluble ODSO to NH₄F (wt./wt.) of, for example, about 4.7-7.9 or 4.7-6.4.

In certain embodiments the homogeneous aqueous mixture has a pH in the range of less than about 11 or less than about 9.0. In some embodiments, the homogeneous aqueous mixture has a pH in the range of about 3-11, 3-9, 3-8, 5-11, 5-5, 5-8, 6-11, 6-9, 6-8, neutral or approaching neutral pH. It is appreciated that the overall pH is influenced by anions from the pH-modified water-soluble ODSO component and any added basic components, and in certain embodiments anions from other sources such as from an alumina source or a silica source. In the process herein, the pH is reduced by the presence of ODSO, therefore, the quantity of the basic compound from one or more of the aforementioned sources including the alkali component of the pH-modified water-soluble ODSO can be adjusted accordingly to attain the requisite pH.

The transition between the crystalline materials and through to amorphous materials (or combinations thereof) is a function of the amount of water-soluble ODSO, for example, the water-soluble ODSO/fluoride ratio or the pH-modified water-soluble ODSO/fluoride ratio. In some embodiments, the amount of ODSO can be fine-tuned and changed to alter the transition between “conventional” MFI zeolites to b-orientated MFI zeolites. The b-orientated MFI zeolites are useful as zeolite membranes.

As demonstrated herein, certain amounts of water-soluble ODSO added to precursors and reagents effective for synthesis of a MFI zeolite, Silicalate-1, also yields Silicalate-1; as the level increases, b-oriented MFI zeolite is present together with Silicalate-1. At certain amounts of water-soluble ODSO above that which produces b-oriented MFI zeolite together with Silicalate-1, b-oriented MFI zeolite is present in pure phase. Increasing the amount of ODSO above that which is effective to produce pure phase b-oriented MFI zeolite yields b-oriented MFI zeolite together with other materials including amorphous material. At the highest levels of ODSO, no zeolites are produces and the synthesized materials are amorphous.

In certain embodiments, a pH-modified water-soluble ODSO composition and a fluoride-containing mineralizer are used in the synthesis of porous crystalline materials that allow for more water substitution than that of a comparative porous crystalline material, and wherein the comparative porous crystalline material is formed of approximately equivalent composition of components except for water-soluble ODSO (non-pH-modified) instead of the added pH-modified water-soluble ODSO composition. In certain embodiments, neutralized water-soluble ODSO and fluoride-containing mineralizer are used in the synthesis of porous crystalline materials that allow for synthesis at a pH that is closer to neutral than that of a comparative porous crystalline material, and wherein the comparative porous crystalline material is formed of approximately equivalent composition of components except for water-soluble ODSO (non-pH-modified) instead of the added pH-modified water-soluble ODSO composition. For example, use of a basic, non-fluoride-containing mineralizer (such as a hydroxide) results in a synthesis of porous crystalline material at a pH of about 13-14, whereas herein using a fluoride-containing mineralizer as in the methods herein permits synthesis at a pH that is closer to neutral, for example, 9-8.

In certain embodiments, the one or more ODSO compounds are contained in a mixture with one or more catalytically active components and ODSO, as an active component carrier composition (as disclosed in co-pending and commonly owned U.S. application Ser. No. 17/720,434 filed Apr. 14, 2022, entitled “Active Component Carrier Composition, and Method for Manufacture of Catalyst Materials,” which is incorporated by reference herein in its entirety). One or more catalytically active components are included in a mixture with one or more ODSO compounds. The one or more active components can vary, depending upon the application of the catalyst being manufactured. The active component can be a metal or a non-metal, in elemental form or as a compound such as oxides, carbides or sulfides. For instance, one or more active components for hydrotreating catalysts can include one or more metals or metal compounds selected from the Periodic Table of the Elements IUPAC Groups 4-12. In certain embodiments one or more active components are selected for producing hydrotreating catalysts and can include one or more metals or metal compounds selected from the Periodic Table of the Elements IUPAC Groups 6-10 (for example Co, Ni, Mo, and combinations thereof). In certain embodiments one or more active components are selected for producing hydrocracking catalysts and can include one or more metals or metal compounds selected from the Periodic Table of the Elements IUPAC Groups 6-10 (for example Co, Ni, W, Mo, and combinations thereof). In certain embodiments one or more active components are selected for producing catalytic reforming catalysts and can include one or more metals or metal compounds selected from the Periodic Table of the Elements IUPAC Groups 8-10 (for example Pt or Pd). In certain embodiments one or more active components are selected for producing hydrogenation catalysts and can include one or more metals or metal compounds selected from the Periodic Table of the Elements IUPAC Groups 7-10 (for example Pt or Pd), and/or one or more non-metal compound such as P. In certain embodiments one or more active components are selected for producing oxidation catalysts and can include one or more metals or metal compounds selected from the Periodic Table of the Elements IUPAC Groups 4-10 (for example Ti, V, Mn, Co, Fe, Cr and Mo) or from the Periodic Table of the Elements IUPAC Groups 4-12 (for example Ti, V, Mn, Co, Fe, Cr, Cu, Zn, W, Mo).

In certain embodiments, the produced aqueous liquid mixture comprises one or more ODSO compounds that are contained in reaction products, or a fraction of reaction products, derived from controlled catalytic oxidation of disulfide oil compounds in the presence of an oxidation catalyst containing one or more transition metals. For example, as described above and in commonly owned U.S. Pat. No. 10,807,947 which is incorporated by reference herein in its entirety, a controlled catalytic oxidation of MEROX process by-products DSO can be carried out. The resulting oxidized effluents contain ODSO. As disclosed in U.S. Pat. No. 10,807,947, the by-product DSO compounds from the mercaptan oxidation process can be oxidized, typically in the presence of a catalyst. The oxidant can be a liquid peroxide selected from the group consisting of alkyl hydroperoxides, aryl hydroperoxides, dialkyl peroxides, diaryl peroxides, peresters and hydrogen peroxide. The oxidant can also be a gas, including air, oxygen, ozone and oxides of nitrogen. In embodiments herein, a catalyst is used in the oxidation process. The oxidation catalyst can contain one active metals from IUPAC Groups 4-10 or from Groups 4-12 of the Periodic Table. In certain embodiments oxidation catalyst are metals or metal compounds containing one or more transition metals. In certain embodiments oxidation catalyst are metals or metal compounds containing one or more metals selected from the group consisting of Ti, V, Mn, Co, Fe, Cr, Cu, Zn, W, Mo and combinations thereof. In certain embodiments oxidation catalyst are compounds containing one or more metals or metal compounds selected from the group consisting of Mo, W, V, Ti, and combinations thereof. In certain embodiments oxidation catalyst are compounds containing one or more metals or metal compounds selected from the group consisting of Mo (VI), W (VI), V (V), Ti (IV), and combinations thereof. In certain embodiments, suitable homogeneous catalysts include molybdenum acetylacetonate, bis (acetylacetonate) dioxomolybdenum, molybdenum naphthenate, molybdenum hexacarbonyl, tungsten hexacarbonyl, sodium tungstate and vanadium pentoxide. In certain embodiments, a suitable catalyst is sodium tungstate, Na₂WO₄.2H₂O.

In certain embodiments in which a pH-modified water-soluble ODSO composition is used, the initial water-soluble ODSO used in the pH-modified water-soluble ODSO composition contains a first weight percent of active component(s) including metals such as transition metals, and the pH-modified water-soluble ODSO composition contains a lesser weight percent of active component(s) than the first quantity of active component(s).

In certain embodiments ODSO is obtained from controlled catalytic oxidation of disulfide oils from mercaptan oxidation processes. The effluents from controlled catalytic oxidation of disulfide oils from mercaptan oxidation processes includes ODSO compounds and in certain embodiments DSO compounds that were unconverted in the oxidation process. In certain embodiments this effluent contains water-soluble compounds and water-insoluble compounds. The effluent contains at least one ODSO compound, or a mixture of two or more ODSO compounds, selected from the group consisting of compounds having the general formula (R—SO—S—R′), (R—SOO—S—R′), (R—SOO—SO—R′), (R—SOO—SOO—R′), (R—SO—SO—R′), (R—SO—SOO—OH), (R—SOO—SOO—OH), (R—SO—SO—OH), (R—SOO—SO—OH), (R′—SO—SO—OR), (R′—SOO—SO—OR), (R′—SO—SOO—OR) and (R′—SOO—SOO—OR). In certain embodiments, in the above formulae R and R′ can be the same or different C1-C10 alkyl or C6-C10 aryl. It will be understood that since the source of the DSO is a refinery feedstream, the R and R′ substituents vary, such as, methyl and ethyl subgroups, and the number of sulfur atoms, S, in the as-received feedstream to oxidation can extend to 3, for example, trisulfide compounds.

In embodiments herein the water-soluble compounds and water-insoluble compounds are separated from one another, and the ODSO used herein comprises all or a portion of the water-soluble compounds separated from the total effluents from oxidation of disulfide oils from mercaptan oxidation processes. For example, the different phases can be separated by decantation or partitioning with a separating funnel, separation drum, by decantation, or any other known apparatus or process for separating two immiscible phases from one another. In certain embodiments, the water-soluble and water-insoluble components can be separated by distillation as they have different boiling point ranges. It is understood that there will be crossover of the water-soluble and water-insoluble components in each fraction due to solubility of components, typically in the ppmw range (for instance, about 1-10,000, 1-1,000, 1-500 or 1-200 ppmw). In certain embodiments, contaminants from each phase can be removed, for example by stripping or adsorption.

In certain embodiments ODSO used herein comprises, consists of or consists essentially of at least one ODSO compound having 3 or more oxygen atoms that is selected from the group consisting of compounds having the general formula (R—SOO—SO—R′), (R—SOO—SOO—R′), (R—SO—SOO—OH), (R—SOO—SOO—OH), (R—SOO—SO—OH), (R—SO—SO—OR′), (R—SOO—SO—OR′), (R—SO—SOO—OR′) and (R—SOO—SOO—OR′). In certain embodiments ODSO used herein comprises, consists of or consists essentially of a mixture of two or more ODSO compounds having 3 or more oxygen atoms, that is selected from the group consisting of compounds having the general formula (R—SOO—SO—R′), (R—SOO—SOO—R′), (R—SO—SOO—OH), (R—SOO—SOO—OH), (R—SOO—SO—OH), (R—SO—SO—OR′), (R—SOO—SO—OR′), (R—SO—SOO—OR′) and (R—SOO—SOO—OR′). In certain embodiments ODSO used herein comprises, consists of or consists essentially of ODSO compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), and mixtures thereof. In certain embodiments, in the above formulae R and R′ can be the same or different C1-C10 alkyl or C6-C10 aryl. In certain embodiments, the R and R′ are methyl and/or ethyl groups. In certain embodiments, the WS-ODSO compound(s) used herein have 1 to 20 carbon atoms.

In some embodiments, the ODSO compounds used as a component for MFI zeolite synthesis are derived from oxidized DSO compounds present in an effluent refinery hydrocarbon stream recovered following the catalytic oxidation of mercaptans present in the hydrocarbon stream, and such methods advantageously reduce the DSO waste from a refinery and discharge into the environment. This ODSO is derived from a sulfur-containing refinery waste stream of disulfide oil. In some embodiments, the DSO compounds are oxidized in the presence of a catalyst. The effluent hydrocarbon stream recovered following the catalytic oxidation of DSO, derived from the catalytic oxidation of mercaptans present in a mercaptan-containing hydrocarbon stream, generally comprises a mixture of ODSO compounds described herein and sulfur compounds including sulfonic acids, for example, methane sulfonic acid, ethane sulfonic acid, or an alkyl sulfonic acid (the alkyl group being based on the R group of the DSO being oxidized).

In certain embodiments, the ODSO compounds used herein comprise, consist of or consist essentially of ODSO compounds having an average density greater than about 1.0 g/cc. In certain embodiments, the ODSO compounds used herein comprise, consist of or consist essentially of ODSO compounds having an average boiling point greater than about 80° C. In certain embodiments, the ODSO compounds used herein comprise, consist of or consist essentially of ODSO compounds having a dielectric constant that is less than or equal to 100 at 0° C.

Table 2 includes examples of polar ODSO compounds that contain 3 or more oxygen atoms. In certain embodiments the identified ODSO compounds are obtained from a water-soluble fraction of the effluents from oxidation of DSO obtained from MEROX by-products. The ODSO compounds that contain 3 or more oxygen atoms are water-soluble over effectively all concentrations, for instance, with some minor amount of acceptable tolerance for carry over components from the effluent stream and in the water insoluble fraction with 2 oxygen atoms of no more than about 1, 3 or 5 mass percent.

In certain embodiments the ODSO compounds contained in an oxidation effluent stream that is derived from controlled catalytic oxidation of MEROX process by-products, DSO compounds, as disclosed in U.S. Pat. Nos. 10,807,947 and 10,781,168 and as incorporated herein by reference above.

In some embodiments, the ODSO are derived from oxidized DSO compounds present in an effluent refinery hydrocarbon stream recovered following the catalytic oxidation of mercaptans present in the hydrocarbon stream. In some embodiments, the DSO compounds are oxidized in the presence of a catalyst.

As noted above, the designation “MEROX” originates from the function of the process itself, that is, the conversion of mercaptans by oxidation. The MEROX process in all of its applications is based on the ability of an organometallic catalyst in a basic environment, such as a caustic, to accelerate the oxidation of mercaptans to disulfides at near ambient temperatures and pressures. The overall reaction can be expressed as follows:

RSH+¼ O₂→½ RSSR+½ H₂O (1)

where R is a hydrocarbon chain that may be straight, branched, or cyclic, and the chains can be saturated or unsaturated. In most petroleum fractions, there will be a mixture of mercaptans so that the R can have 1, 2, 3 and up to 10 or more carbon atoms in the chain. This variable chain length and type is indicated by R and R′in the reaction. The reaction is then written:

2 R′SH+2 RSH+O₂→2 R′SSR+2 H₂O (2)

This reaction occurs spontaneously whenever any sour mercaptan-bearing distillate is exposed to atmospheric oxygen, but proceeds at a very slow rate. In addition, the catalyzed reaction (1) set forth above requires the presence of an alkali caustic solution, such as aqueous sodium hydroxide. The mercaptan oxidation proceeds at an economically practical rate at moderate refinery downstream temperatures.

The MEROX process can be conducted on both liquid streams and on combined gaseous and liquid streams. In the case of liquid streams, the mercaptans are converted directly to disulfides which remain in the product so that there is no reduction in total sulfur content of the effluent stream. The MEROX process typically utilizes a fixed bed reactor system for liquid streams and is normally employed with charge stocks having end points above 135° C.-150° C. Mercaptans are converted to disulfides in the fixed bed reactor system over a catalyst, for example, an activated charcoal impregnated with the MEROX reagent, and wetted with caustic solution. Air is injected into the hydrocarbon feedstream ahead of the reactor and in passing through the catalyst-impregnated bed, the mercaptans in the feed are oxidized to disulfides. The disulfides are substantially insoluble in the caustic and remain in the hydrocarbon phase. Post treatment is required to remove undesirable by-products resulting from known side reactions such as the neutralization of H₂S, the oxidation of phenolic compounds, entrained caustic, and others.

The vapor pressures of disulfides are relatively low compared to those of mercaptans, so that their presence is much less objectionable from the standpoint of odor; however, they are not environmentally acceptable due to their sulfur content and their disposal can be problematical.

In the case of mixed gas and liquid streams, extraction is applied to both phases of the hydrocarbon streams. The degree of completeness of the mercaptan extraction depends upon the solubility of the mercaptans in the alkaline solution, which is a function of the molecular weight of the individual mercaptans, the extent of the branching of the mercaptan molecules, the concentration of the caustic soda and the temperature of the system. Thereafter, the resulting DSO compounds are separated, and the caustic solution is regenerated by oxidation with air in the presence of the catalyst and reused.

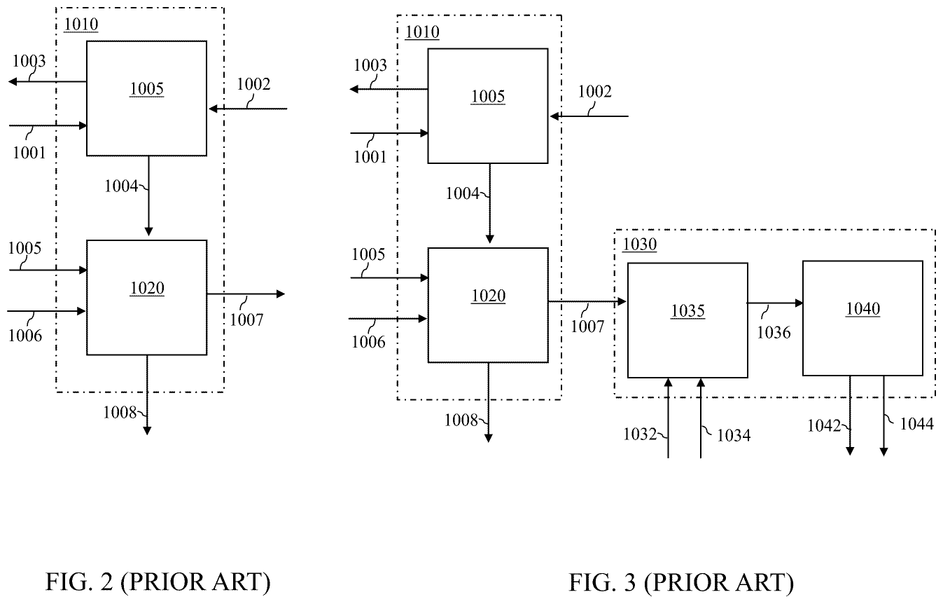

Referring to the attached drawings, FIG. 2 is a simplified schematic of a generalized version of a conventional MEROX process employing liquid-liquid extraction for removing sulfur compounds. A MEROX unit 1010, is provided for treating a mercaptan containing hydrocarbon stream 1001. In some embodiments, the mercaptan containing hydrocarbon stream 1001 is LPG, propane, butane, light naphtha, kerosene, jet fuel, or a mixture thereof. The process generally includes the steps of: introducing the hydrocarbon stream 1001 with a homogeneous catalyst into an extraction vessel 1005 containing a caustic solution 1002, in some embodiments, the catalyst is a homogeneous cobalt-based catalyst; passing the hydrocarbon catalyst stream in counter-current flow through the extraction section of the extraction 1005 vessel in which the extraction section includes one or more liquid-liquid contacting extraction decks or trays (not shown) for the catalyzed reaction with the circulating caustic solution to convert the mercaptans to water-soluble alkali metal alkane thiolate compounds; withdrawing a hydrocarbon product stream 1003 that is free or substantially free of mercaptans from the extraction vessel 1005, for instance, having no more than about 1000, 100, 10 or 1 ppmw mercaptans; recovering a combined spent caustic and alkali metal alkane thiolate stream 1004 from the extraction vessel 1005; subjecting the spent caustic and alkali metal alkane thiolate stream 1004 to catalyzed wet air oxidation in a reactor 1020 into which is introduced catalyst 1005 and air 1006 to provide the regenerated spent caustic 1008 and convert the alkali metal alkane thiolate compounds to disulfide oils; and recovering a by-product stream 1007 of DSO compounds and a minor proportion of other sulfides such as mono-sulfides and tri-sulfides. The effluents of the wet air oxidation step in the MEROX process can comprise a minor proportion of sulfides and a major proportion of disulfide oils. As is known to those skilled in the art, the composition of this effluent stream depends on the effectiveness of the MEROX process, and sulfides are assumed to be carried-over material. A variety of catalysts have been developed for the commercial practice of the process. The efficiency of the MEROX process is also a function of the amount of H₂S present in the stream. It is a common refinery practice to install a prewashing step for H₂S removal.

An enhanced MEROX process (“E-MEROX”) is a modified MEROX process where an additional step is added, in which DSO compounds are oxidized with an oxidant in the presence of a catalyst to produce a mixture of ODSO compounds. The by-product DSO compounds from the mercaptan oxidation process are oxidized, in some embodiments in the presence of a catalyst, and constitute an abundant source of ODSO compounds that are sulfoxides, sulfonates, sulfinates, sulfones and their corresponding di-sulfur mixtures. The disulfide oils having the general formula RSSR′ (wherein R and R′ can be the same or different and can have 1, 2, 3 and up to 10 or more carbon atoms) can be oxidized without a catalyst or in the presence of one or more catalysts to produce a mixture of ODSO compounds. The oxidant can be a liquid peroxide selected from the group consisting of alkyl hydroperoxides, aryl hydroperoxides, dialkyl peroxides, diaryl peroxides, peresters and hydrogen peroxide. The oxidant can also be a gas, including air, oxygen, ozone and oxides of nitrogen. If a catalyst is used in the oxidation of the disulfide oils having the general formula RSSR′ to produce the ODSO compounds, it can be a heterogeneous or homogeneous oxidation catalyst. The oxidation catalyst can be selected from one or more heterogeneous or homogeneous catalyst comprising metals from the IUPAC Group 4-12 of the Periodic Table, including Ti, V, Mn, Co, Fe, Cr, Cu, Zn, W and Mo. The catalyst can be a homogeneous water-soluble compound that is a transition metal containing an active species selected from the group consisting of Mo (VI), W (VI), V (V), Ti (IV), and combinations thereof. In certain embodiments, suitable homogeneous catalysts include molybdenum naphthenate, sodium tungstate, molybdenum hexacarbonyl, tungsten hexacarbonyl, sodium tungstate and vanadium pentoxide. An exemplary catalyst for the controlled catalytic oxidation of MEROX process by-products DSO is sodium tungstate, Na₂WO₄.2H₂O. In certain embodiments, suitable heterogeneous catalysts include Ti, V, Mn, Co, Fe, Cr, W, Mo, and combinations thereof deposited on a support such as alumina, silica-alumina, silica, natural zeolites, synthetic zeolites, and combinations comprising one or more of the above supports.

The oxidation of DSO typically is carried out in an oxidation vessel selected from one or more of a fixed-bed reactor, an ebullated bed reactor, a slurry bed reactor, a moving bed reactor, a continuous stirred tank reactor, and a tubular reactor. The ODSO compounds produced in the E-MEROX process generally comprise two phases: a water-soluble phase and water-insoluble phase, and can be separated into the aqueous phase containing water-soluble ODSO compounds and a non-aqueous phase containing water-insoluble ODSO compounds. The E-MEROX process can be tuned depending on the desired ratio of water-soluble to water-insoluble compounds presented in the product ODSO mixture. Partial oxidation of DSO compounds results in a higher relative amount of water-insoluble ODSO compounds present in the ODSO product and a near or almost complete oxidation of DSO compounds results in a higher relative amount of water-soluble ODSO present in the ODSO product. Details of the ODSO compositions are discussed in the U.S. Pat. No. 10,781,168, which is incorporated herein by reference above.

FIG. 3 is a simplified schematic of an E-MEROX process that includes E-MEROX unit 1030. The MEROX unit 1010 unit operates similarly as in FIG. 2, with similar references numbers representing similar units/feeds. In FIG. 3, the effluent stream 1007 from the generalized MEROX unit of FIG. 2 is treated. It will be understood that the processing of the mercaptan containing hydrocarbon stream of FIG. 3 is illustrative only and that separate streams of the products, and combined or separate streams of other mixed and longer chain products can be the subject of the process for the recovery and oxidation of DSO to produce ODSO compounds, that is the E-MEROX process. In order to practice the E-MEROX process, apparatus are added to recover the by-product DSO compounds from the MEROX process. In addition, a suitable reactor 1035 add into which the DSO compounds are introduced in the presence of a catalyst 1032 and an oxidant 1034 and subjecting the DSO compounds to a catalytic oxidation step to produce the mixed stream 1036 of water and ODSO compounds. A separation vessel 1040 is provided to separate the by-product 1044 from the ODSO compounds 1042.

The oxidation to produce OSDO can be carried out in a suitable oxidation reaction vessel operating at a pressure in the range from about 1-30, 1-10 or 1-3 bars. The oxidation to produce OSDO can be carried out at a temperature in the range from about 20-300, 20-150, 20-90, 45-300, 15-150 or 45-90° C. The molar feed ratio of oxidizing agent-to-mono-sulfur can be in the range of from about 1:1 to 100:1, 1:1 to 30:1 or 1:1 to 4:1. The residence time in the reaction vessel can be in the range of from about 5-180, 5-90, 5-30, 15-180, 15-90 or 5-30 minutes. In certain embodiments, oxidation of DSO is carried out in an environment without added water as a reagent. The by-products stream 1044 generally comprises wastewater when hydrogen peroxide is used as the oxidant. Alternatively, when other organic peroxides are used as the oxidant, the by-products stream 1044 generally comprises the alcohol of the peroxide used. For example, if butyl peroxide is used as the oxidant, the by-product alcohol 1044 is butanol.

In certain embodiments water-soluble ODSO compounds are passed to a fractionation zone (not shown) for recovery following their separation from the wastewater fraction. The fractionation zone can include a distillation unit. In certain embodiments, the distillation unit can be a flash distillation unit with no theoretical plates in order to obtain distillation cuts with larger overlaps with each other or, alternatively, on other embodiments, the distillation unit can be a flash distillation unit with at least 15 theoretical plates in order to have effective separation between cuts. In certain embodiments, the distillation unit can operate at atmospheric pressure and at a temperature in the range of from 100° C. to 225° C. In other embodiments, the fractionation can be carried out continuously under vacuum conditions. In those embodiments, fractionation occurs at reduced pressures and at their respective boiling temperatures. For example, at 350 mbar and 10 mbar, the temperature ranges are from 80° C. to 194° C. and 11° C. to 98° C., respectively. Following fractionation, the wastewater is sent to the wastewater pool (not shown) for conventional treatment prior to its disposal. The wastewater by-product fraction can contain a small amount of water-insoluble ODSO compounds, for example, in the range of from 1 to 10,000 ppmw. The wastewater by-product fraction can contain a small amount of water-soluble ODSO compounds, for example, in the range of from 1 to 50,000 ppmw, or 100 to 50,000 ppmw. In embodiments where alcohol is the by-product alcohol, the alcohol can be recovered and sold as a commodity product or added to fuels like gasoline. The alcohol by-product fraction can contain a small amount of water-insoluble ODSO compounds, for example, in the range of from 1 to 10,000 ppmw. The alcohol by-product fraction can contain a small amount of water-soluble ODSO compounds, for example, in the range of from 100 to 50,000 ppmw.

### EXAMPLES

The below examples and data are exemplary. It is to be understood that other ratios and types of aluminum sources, silica sources, bases and structure directing agents can be used as compared to the examples.

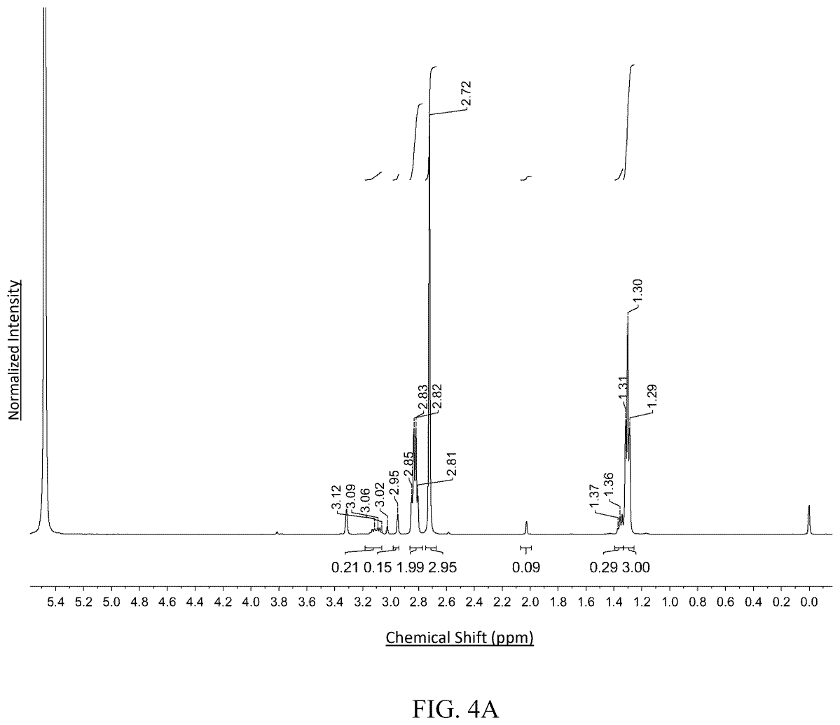

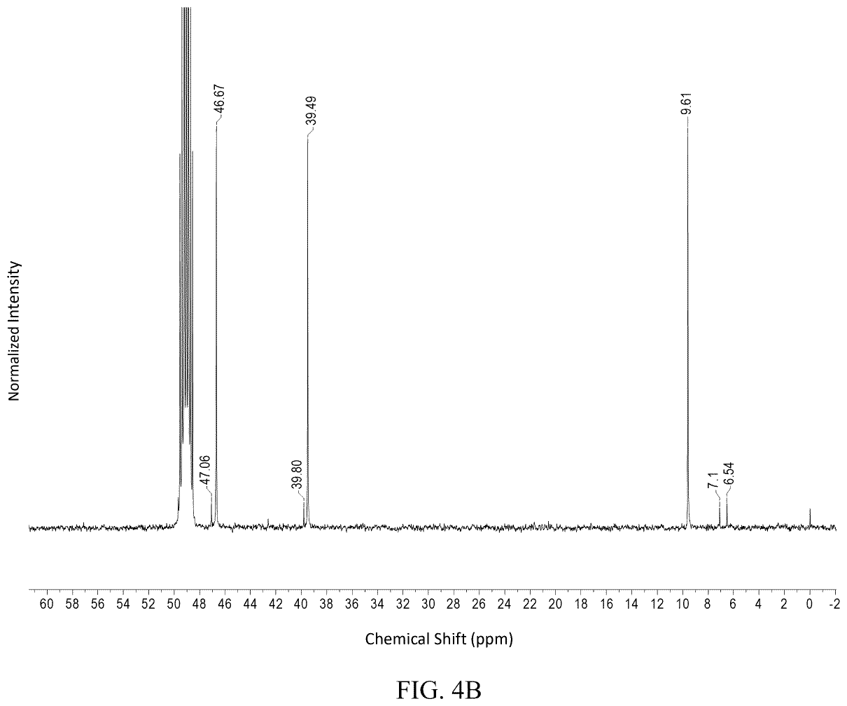

Reference Example: The ODSO mixtures used in the Examples below were produced as disclosed in U.S. Pat. No. 10,781,168, incorporated by reference above, and in particular the fraction referred to therein as Composition 2. Catalytic oxidation a hydrocarbon refinery feedstock having 98 mass percent of C1 and C2 disulfide oils was carried out. The oxidation of the DSO compounds was performed in batch mode under reflux at atmospheric pressure, that is, approximately 1.01 bar. The hydrogen peroxide oxidant was added at room temperature, that is, approximately 23° C. and produced an exothermic reaction. The molar ratio of oxidant-to-DSO compounds (calculated based upon mono-sulfur content) was 2.90. After the addition of the oxidant was complete, the reaction vessel temperature was set to reflux at 80° C. for approximately one hour. after which the water soluble ODSO was produced (referred to as Composition 2 herein and in U.S. Pat. No. 10,781,168) and isolated after the removal of water. The catalyst used in the oxidation of the DSO compounds was sodium tungstate. The Composition 2, referred to herein as “the selected water soluble ODSO fraction,” was used. FIG. 4A is the experimental ¹H-NMR spectrum of the polar, water soluble ODSO mixture that is the selected water soluble ODSO fraction in the example herein. FIG. 4B is the experimental ¹³C-DEPT-135-NMR spectrum of the polar, water soluble ODSO mixture that is the selected water soluble ODSO fraction in the example herein. The selected water soluble ODSO fraction was mixed with a CD₃OD solvent and the spectrum was taken at 25° C. Methyl carbons have a positive intensity while methylene carbons exhibit a negative intensity. The peaks in the 48-50 ppm region belong to carbon signals of the CD₃OD solvent.

When comparing the experimental ¹³C-DEPT-135-NMR spectrum of FIG. 4B for the selected water soluble ODSO fraction with a saved database of predicted spectra, it was found that a combination of the predicted alkyl-sulfoxidesulfonate (R—SO—SOO—OH), alkyl-sulfonesulfonate (R—SOO—SOO—OH), alkyl-sulfoxidesulfinate (R—SO—SO—OH) and alkyl-sulfonesulfinate (R—SOO—SO—OH) most closely corresponded to the experimental spectrum. This suggests that alkyl-sulfoxidesulfonate (R—SO—SOO—OH), alkyl-sulfonesulfonate (R—SOO—SOO—OH), alkyl-sulfoxidesulfinate (R—SO—SO—OH) and alkyl-sulfonesulfinate (R—SOO—SO—OH) are major compounds in the selected water soluble ODSO fraction. It is clear from the NMR spectra shown in FIGS. 4A and 4B that the selected water soluble ODSO fraction comprises a mixture of ODSO compounds that form an ODSO acid of the present disclosure and used in the present examples.

Comparative Example 1: A comparative Silicalite-1 zeolite was prepared using conventional precursors and water as solvent. Tetrapropylammonium bromide (TPABr, 0.7542 g, 98 wt. %) and ammonium fluoride (NH₄F, 1.3113 g, 98 wt. %) were weighed into a polytetrafluoroethylene (PTFE) liner (45 ml). Next, distilled water (4.0000 g) was added and the mixture was stirred until the salts dissolved. Distilled water (8.0000 g) was added to fumed silica (2.0849 g, 100 wt. %) and the mixture stirred until homogeneous. The silica-containing mixture was added to the TPABr/NH₄F-containing mixture. Further distilled water (0.4510 g) was used to remove residual silica from its container to the Teflon liner. The sol-gel was homogenized before transferring to an autoclave. The PTFE liner was positioned within an autoclave and transferred to an oven and heated to a temperature of 200° C. The autoclave was kept at isothermal conditions for 48 hrs. The product was washed with distilled water and dried. The dry mass was 1.9136 g. X-ray diffraction identified the zeolite as principally Silicalite-1 (MFI).

Examples a: Eighteen (18) examples were carried out, where ODSO was added to replace a certain amount of the water in each of the syntheses with calcined products including MFI zeolites (Silicalite-1 or b-oriented), alone or together with amorphous materials, an in certain examples with higher ODSO loading, amorphous and unknown materials. In each of the examples, a cumulative mass of ODSO and water is approximately equivalent to a mass of water that would otherwise be required to produce the zeolite. The compositions of the precursors, reagents and products are presented in Table 3. For each example, an amount of TPABr (98 wt. %) and NH₄F (98 wt. %) were weighed into a PTFE liner (45 ml). Distilled water (4.0000 g) was added and the mixture stirred until the salts dissolved. A second amount of distilled water) was added to an amount of fumed silica (100 wt. %) and this mixture mixed until homogeneous. An amount of ODSO was added to the silica mixture and the mixture was further mixed until homogeneous. The silica-containing mixture was added to the TPABr/NH₄F-containing mixture and the resulting sol-gel was homogenized and the pH determine (approximated with pH strips) before transferring to an autoclave. The PTFE liner containing the sol-gel was positioned within the autoclave and transferred to an oven and heated to a temperature of 200° C. The autoclave was maintained at isothermal conditions for 48 hours. The pH of the supernatant was determined (approximated with pH strips) and the resulting solid product was washed with distilled water and dried. The dry mass was weighed.

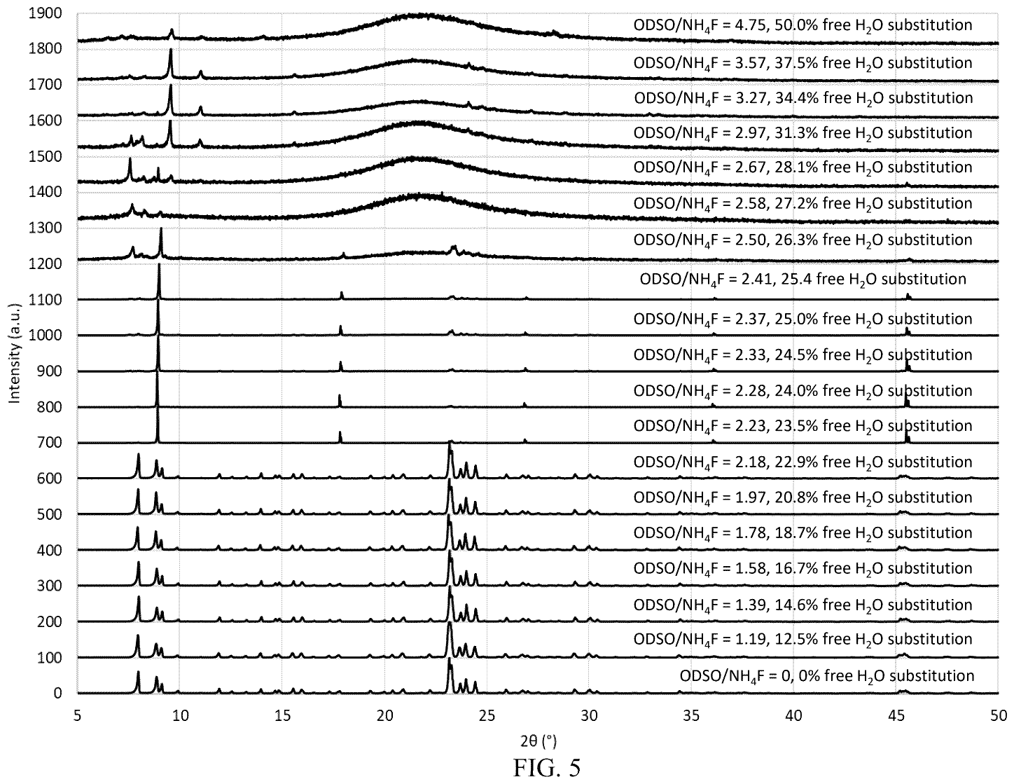

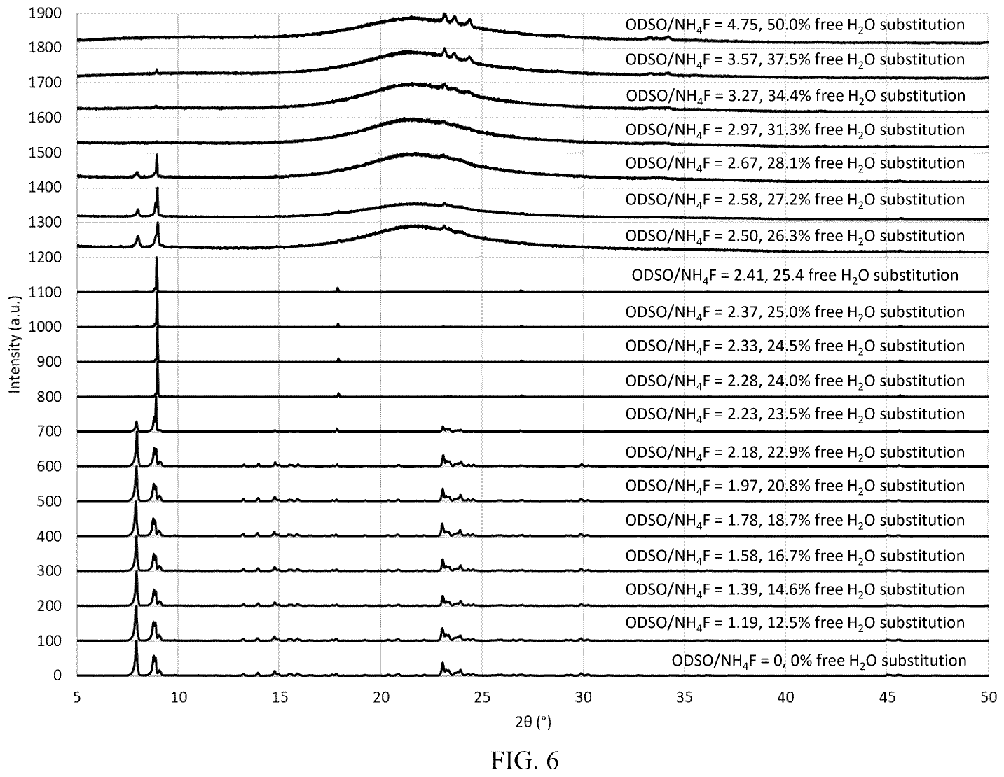

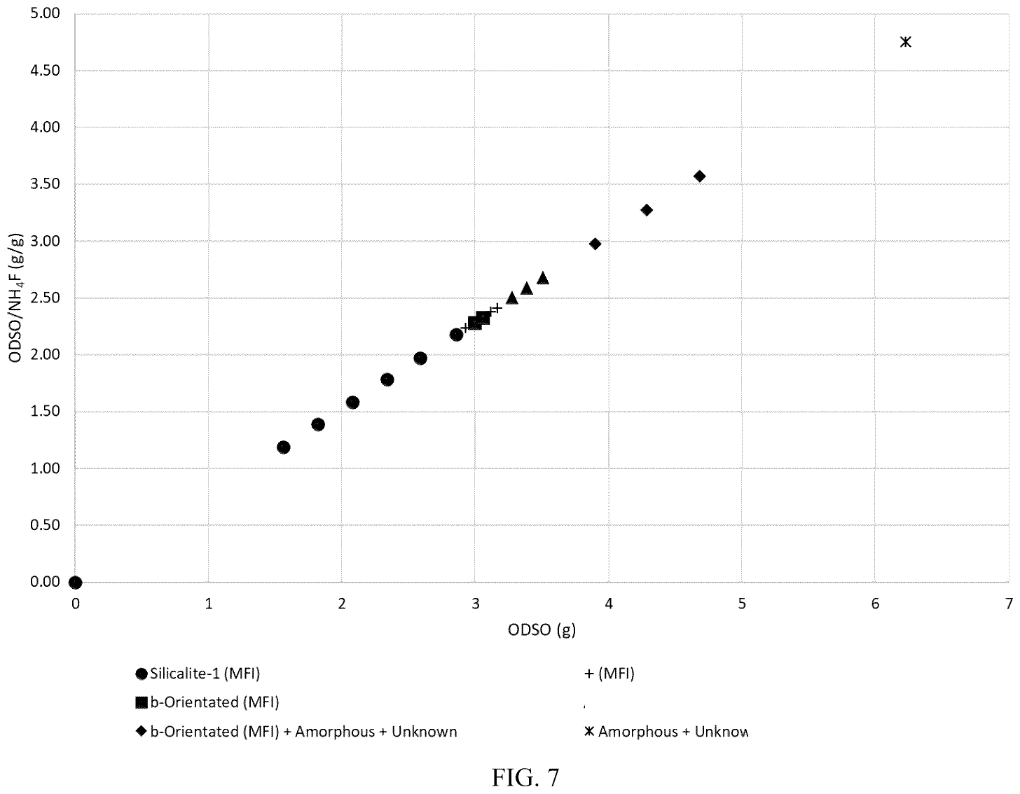

FIG. 5 shows the x-ray diffraction patterns of the as-made products synthesized in the presence of a fluoride mineralizer as a function of the amount of ODSO. FIG. 6 shows the x-ray diffraction of the calcined products synthesized in the presence of a fluoride mineralizer as a function of the level of ODSO substitution for free water. Each pattern is in arbitrary units (a.u.) and is offset on the y-axis by an equivalent amount, and where the x-ray diffraction patterns are normalized to the highest intensity peak, which are effective to compare patterns relative to one another. FIG. 7 plots the phase transition of the synthesized products as a function of the ODSO/NH₄F ratio. From these figures, it can be seen that: Silicalite-1 is synthesized phase pure between at all ODSO/NH₄F ratios in the examples of up to 2.41; the examples at ODSO/NH₄F ratios of 2.28, 2.33, 2.37 and 2.41 yielded b-oriented MFI zeolite; at syntheses in the examples with higher ODSO/NH₄F ratios (up to 3.57) Silicalite-1 is co-synthesized with amorphous material or amorphous material together with an unknown material; at the example with the ODSO/NH₄F ratio of 4.75 amorphous and undetermined material were produced.

It is clear that ODSO can be successfully used in the synthesis of MFI zeolites when in the presence of a fluoride mineralizer. Controlling an effective amount of ODSO, for instance by the level of ODSO substitution of free water, maintains the product within the MFI phase boundary, and yields specific sub-types (e.g., Silicalite-1 or b-oriented MFI zeolite).

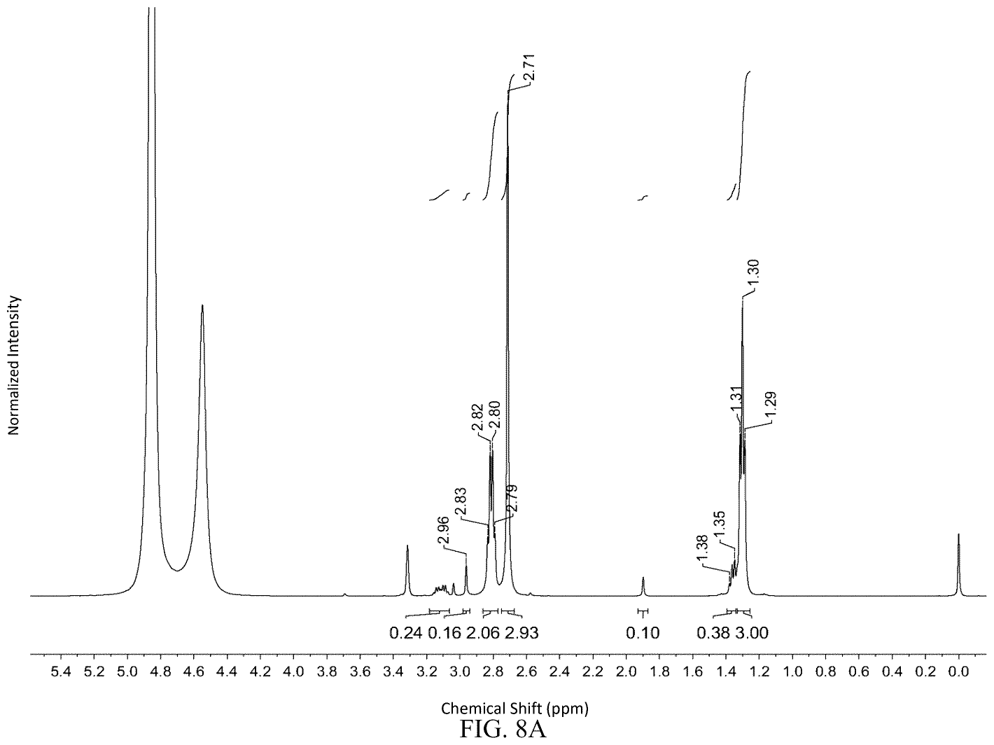

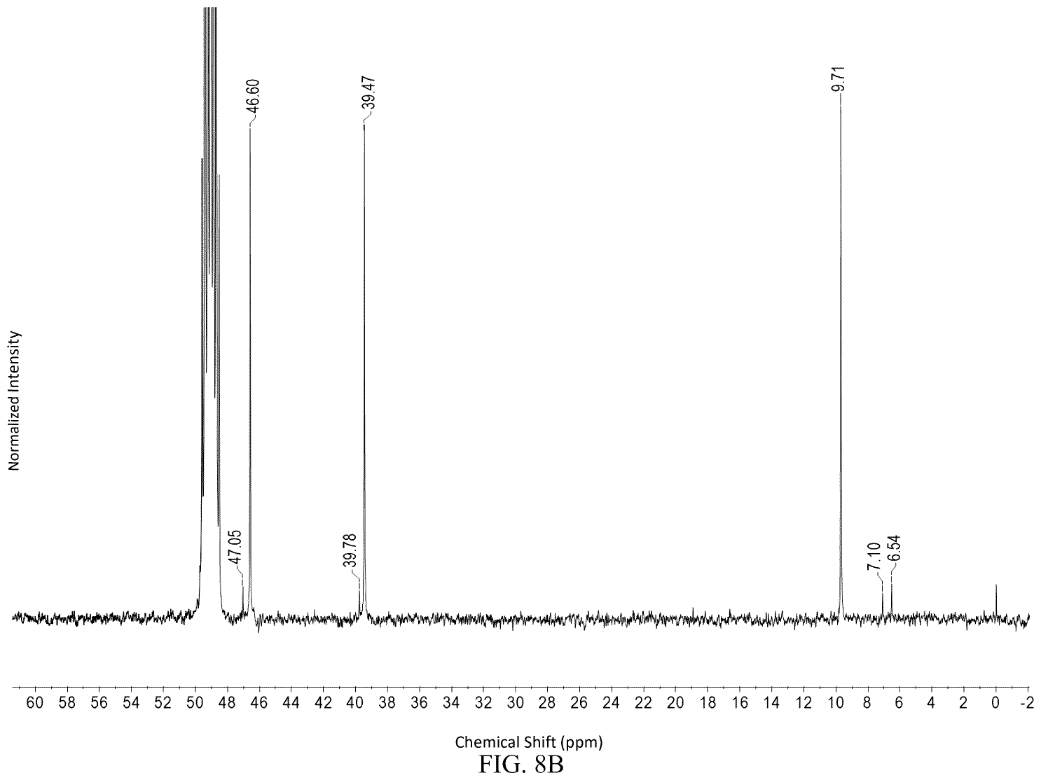

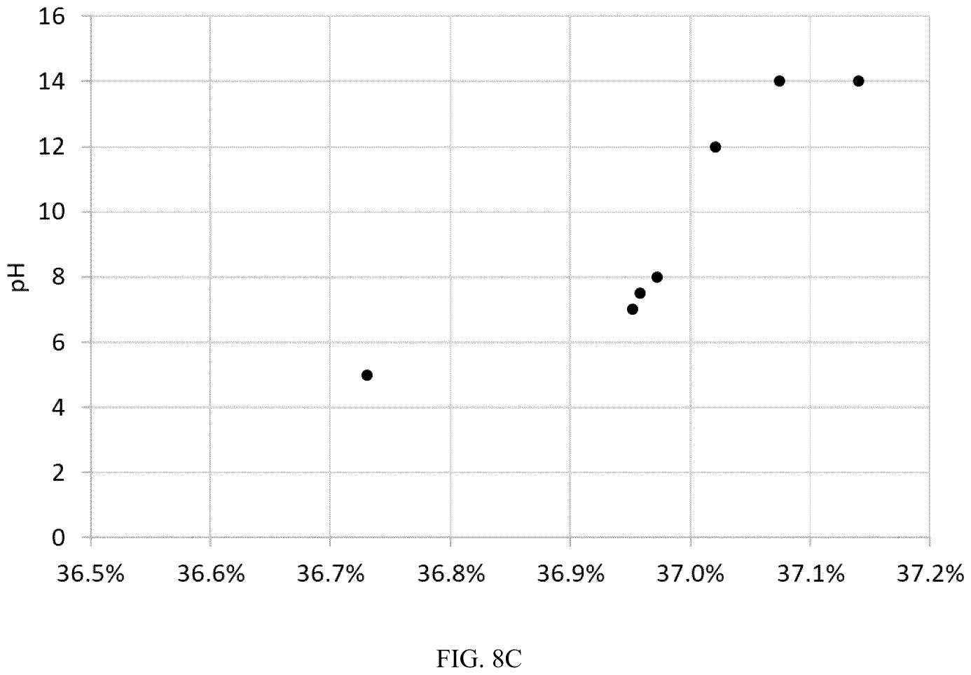

Reference Example 2: The selected water-soluble ODSO fraction as described in Reference Example 1 was subjected to pH-modification to produce a neutralized water-soluble ODSO composition. The selected water-soluble ODSO tested with pH paper produced by VWR International (VWR International, Radnor, PA, USA) and determined to have a pH of approximately 0 or below. To a quantity of 50.6028 g of this water-soluble ODSO, an alkaline agent (50 mass percent aqueous NaOH solution) was added slowly whilst measuring the pH. Gas liberation and heat generation were observed. At a pH of approximately 7, a solid was precipitated. FIG. 8A is the experimental ¹H NMR spectrum of the liquid portion of the neutralized water-soluble ODSO composition, and FIG. 8B is the experimental ¹³C-DEPT-135-NMR spectrum of the neutralized water-soluble ODSO composition. FIG. 8C shows the neutralization curve as a function of the mass percent of the NaOH reagent added to the total solution of NaOH reagent and water-soluble ODSO. This example shows that approximately 36.95 mass percent of 50 mass percent NaOH was required to neutralize the water-soluble ODSO, or approximately 18.5 mass percent NaOH relative to the total mass of the solution of water-soluble ODSO and the selected alkaline agent. The neutralized water-soluble ODSO at pH 7 was separated from the solid. Elemental analysis was performed using Inductively Coupled Plasma (ICP) spectroscopy. Table 2 provides ICP data in the form of the mass percent of Na, S and W in the water-soluble ODSO mixture before neutralization, the neutralized water-soluble ODSO at pH 7 and the solid precipitated from the neutralized water-soluble ODSO at pH 7.

As noted above, ¹H and ¹³C NMR data were obtained for the water-soluble ODSO (FIG. 4A, ¹H NMR spectrum, and FIG. 4B, ¹³C-DEPT-135-NMR spectrum); ¹H and ¹³C NMR data were also obtained for the neutralized water-soluble ODSO at pH 7 (FIG. 8A, ¹H NMR spectrum, and FIG. 8B, ¹³C-DEPT-135-NMR spectrum). The samples were prepared in deuterated methanol using a JEOL 500 MHz spectrometer fitted with a 5 mm liquid-state Royal probe. The spectra and data show that the nature of the water-soluble ODSO components remain unchanged before and after neutralization. Proton NMR spectra and data show that the nature of the water-soluble ODSO components remain unchanged before and after neutralization, however, there is an observable change in the nature of the hydrogen bonded species. In FIG. 4A concerning the water-soluble ODSO prior to neutralization, the peak at approximately 5.5 ppm appears to be a coalescence of protons associated with deuterated methanol (the solvent used to measure the samples), water and other species. However, after neutralization (FIG. 8A) there is a clear peak observed at approximately 4.6 ppm that is expected for the protons from the deuterated methanol and a coalesced peak at approximately 4.9 ppm relating to water and other species. Hence, there is a clear difference of interaction between the two samples with the solvent used to measure the NMR data.

Example b1: A zeolite was synthesized using precursors and pH-modified water-soluble ODSO (neutralized) as described in Reference Example 2 as a component. TPABr (0.7538 g, 98 wt. %) and NH₄F (1.3116 g, 98 wt. %) were weighed into a PTFE liner (45 ml). Next, distilled water (4.0000 g) was added and the mixture was stirred until the salts dissolved. Distilled water (4.3100 g) was added to fumed silica (2.0843 g, 100 wt. %) and the mixture stirred until homogeneous. Next, neutralized water-soluble ODSO from Reference Example 2 (4.1480 g) was added and the mixture was stirred until homogeneous. The silica-containing mixture was added to the TPABr/NH₄F-containing mixture. The sol-gel was homogenized before transferring to an autoclave. The PTFE liner was positioned within an autoclave and transferred to an oven and heated to a temperature of 200° C. The autoclave was kept at isothermal conditions for 48 hrs. The product was washed with distilled water and dried. The dry mass was 1.8921 g. The ratio of the neutralized water-soluble ODSO composition to NH₄F was 3.16 (equivalent to: a ratio of the neutralized water-soluble ODSO composition to F⁻ of about 6.16; free water substitution of about 33.3%; and total water substitution of about 33.2%). X-ray diffraction identified the zeolite as principally Silicalite-1 (MFI).

Example b2: A zeolite was synthesized using precursors and neutralized water-soluble ODSO as described in Reference Example 2 as a component. TPABr (0.7541 g, 98 wt. %) and ammonium fluoride NH₄F (1.3109 g, 98 wt. %) were weighed into a PTFE liner (45 ml). Next, distilled water (4.0000 g) was added and the mixture was stirred until the salts dissolved. Distilled water (0.1610 g) was added to fumed silica (2.0841 g, 100 wt. %) and the mixture stirred until homogeneous. Next, neutralized water-soluble ODSO from Reference Example 2 (8.2951 g) was added and the mixture was stirred until homogeneous. The silica-containing mixture was added to the TPABr/NH₄F-containing mixture. The sol-gel was homogenized before transferring to an autoclave. The PTFE liner was positioned within an autoclave and transferred to an oven and heated to a temperature of 200° C. The autoclave was kept at isothermal conditions for 48 hrs. The product was washed with distilled water and dried. The dry mass was 1.8862 g. The ratio of the neutralized water-soluble ODSO composition to NH₄F was 6.33 (equivalent to: a ratio of the neutralized water-soluble ODSO composition to F⁻ of about 12.34; free water substitution of about 66.6%; and total water substitution of about 66.4%). X-ray diffraction identified the zeolite as a mix of Silicalite-1 (MFI) and b-orientated Silicalite-1 (MFI).

Example b3: A zeolite was synthesized using precursors and neutralized water-soluble ODSO as described in Reference Example 2, without added utility water. TPABr (0.7546 g, 98 wt. %) and NH₄F (1.3108 g, 98 wt. %) were weighed into a polytetrafluoroethylene (PTFE) liner (45 ml). Next, neutralized water-soluble ODSO from Reference Example 2 (4.0000 g) was added and the mixture was stirred until the salts dissolved. An additional amount of neutralized water-soluble ODSO from Reference Example 2 (8.4610 g) was added to fumed silica (2.0845 g, 100 wt. %) and the mixture stirred until homogeneous. The silica-containing mixture was added to the TPABr/NH₄F-containing mixture. The sol-gel was homogenized before transferring to an autoclave. The PTFE liner was positioned within an autoclave and transferred to an oven and heated to a temperature of 200° C. The autoclave was kept at isothermal conditions for 48 hrs. The product was washed with distilled water and dried. The dry mass was 1.7320 g. The ratio of the neutralized water-soluble ODSO composition to NH₄F was 9.51 (equivalent to: a ratio of the neutralized water-soluble ODSO composition to F⁻ of about 18.54; free water substitution of 100% and total water substitution of about 99.7%). X-ray diffraction identified the product as principally amorphous material.

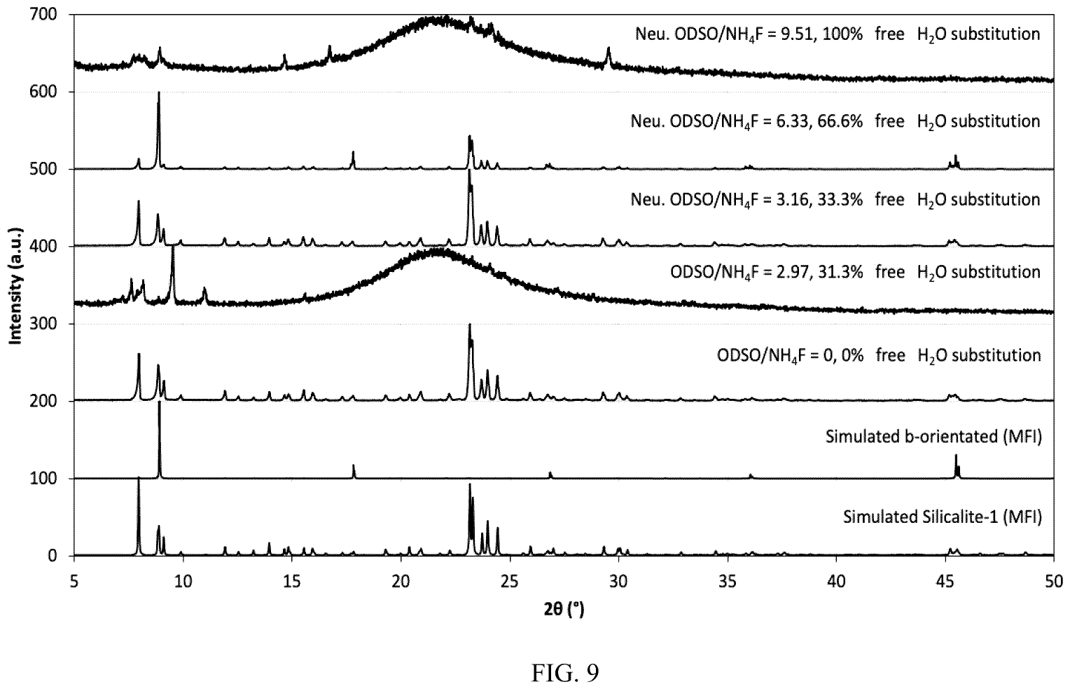

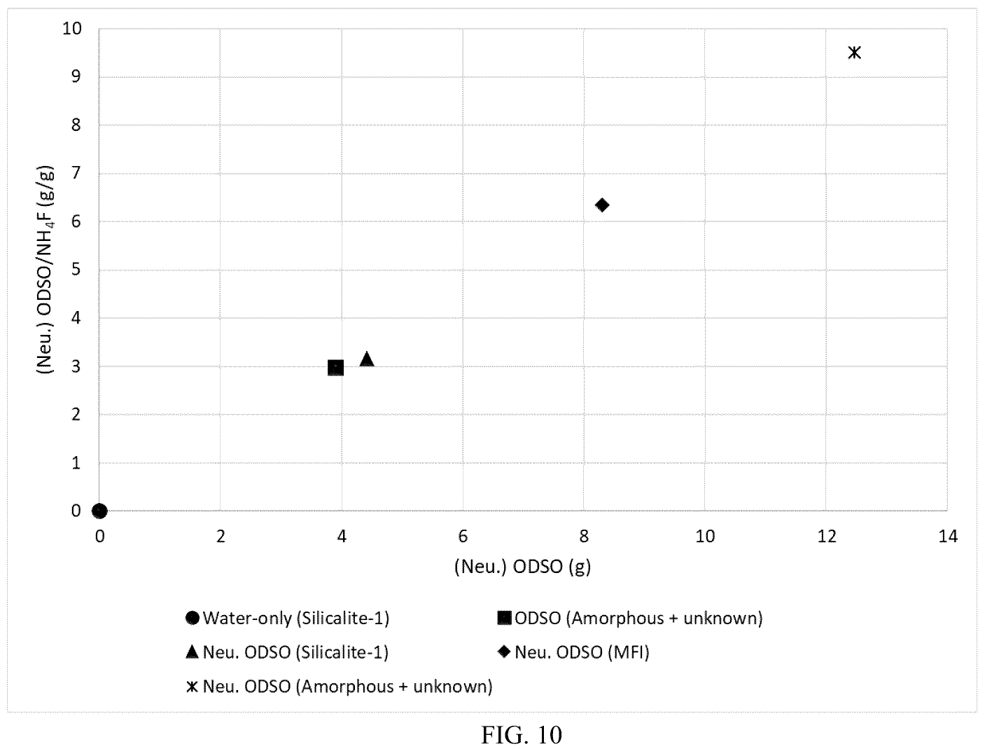

FIG. 9 shows the x-ray diffraction patterns of the as-made products from the Comparative Examples 1, the example 15 from Table 3, and Examples b1-b3, and the simulated x-ray diffraction pattern of Silicalite-1 (MFI) and b-orientated MFI. Each pattern is in arbitrary units (a.u.) and is offset on the y-axis by an equivalent amount, and where the x-ray diffraction patterns are normalized to the highest intensity peak, which are effective to compare patterns relative to one another. FIG. 10 plots the phase transition of the products as a function of the neutralized ODSO/NH₄F ratio (Neu. ODSO) or the ODSO/NH₄F ratio (non-neutralized) as indicated in the legends. Silicalite-1 (MFI) and b-orientated MFI zeolite are synthesized with the neutralized ODSO/NH₄F ratios in Examples 1 and 2. When non-neutralized ODSO is used in Example 15 from Table 3 at an ODSO/NH₄F ratio of 2.97, amorphous material is present. At the neutralized ODSO/NH₄F ratio of 3.16, Silicalite-1 (MFI) is synthesized. At the neutralized ODSO/NH₄F ratio of 6.33, b-orientated MFI zeolite and Silicalite-1 (MFI) are synthesized. FIG. 10 demonstrates that the tolerance to maintain within the MFI phase boundary is over a vastly wider range when switching to neutralized ODSO from non-neutralized ODSO, and concomitantly, the level of water substitution level is far greater. It is clear that the neutralized ODSO can be successfully used in the synthesis of MFI zeolites when in the presence of a fluoride mineralizer. Furthermore, the level of ODSO substitution of free water is significantly increased when switching to neutralized ODSO (Example b2) from non-neutralized ODSO (Example 15, Table 3).

In the description herein, the terms “sol-gel”, “colloidal”, “sol-gel/colloidal”, and “homogeneous aqueous mixture” may be used interchangeably for convenience.

As used herein, “approximately equivalent” as concerning the amount of ODSO that replaces water, the cumulative amount of ODSO and water, the component molar or mass ratios, and/or the hydrolysis conditions and time, is within a margin of less than or equal to plus or minus 1, 2, 5 or 10% of the compared value.

The methods of preparing porous crystalline materials described above and characterized in the attached figures are exemplary, and process modifications and variations will be apparent to those of ordinary skill in the art and the scope of protection for the invention is to be defined by the claims that follow.

It is to be understood that like numerals in the drawings represent like elements through the several figures, and that not all components and/or steps described and illustrated with reference to the figures are required for all embodiments or arrangements. Further, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “including,” “comprising,” or “having,” “containing,” “involving,” and variations thereof herein, when used in this specification, specify the presence of stated features, integers, steps, operations, elements, and/or components, but do not preclude the presence or addition of one or more other features, integers, steps, operations, elements, components, and/or groups thereof.

Notably, the figures and examples above are not meant to limit the scope of the present disclosure to a single implementation, as other implementations are possible by way of interchange of some or all the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific implementations will so fully reveal the general nature of the disclosure that others can, by applying knowledge within the skill of the relevant art(s), readily modify and/or adapt for various applications such specific implementations, without undue experimentation, without departing from the general concept of the present disclosure. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown are drawings accordingly to one example and other dimensions can be used without departing from the disclosure.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

TABLE 1

| Idealized | Crystal | | | | | | |
|---|---|---|---|---|---|---|---|
| cell data | chemical data | | | | | Channel | Channel |
| a, b and c | a, b and c | # of T | Composite | | | size | size |
| parameters | parameters | atoms in | building | Framework | Member | [100] | [010] |
| (Å) | (Å) | unit cell | units | density | ring size | (Å) | (Å) |
| a = 20.1 | a = 20.07 | 96 | MOR, CAS, | 17.9 T/ | 10 | 5.1 × 5.5 | 5.3 × 5.6 |
| b = 19.7 | b = 19.92 | | MEL, MFI | 1000 Å³ | | | |
| c = 13.1 | c = 13.42 | | | | | | |

TABLE 2

| ODSO Name | Formula | Structure Examples |
|---|---|---|
| Dialkyl- sulfonesulfoxide Or 1,2-alkyl-alkyl- disulfane 1,1,2-trioxide | (R—SOO—SO—R′) | 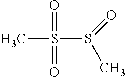 |
| | | 1,2-Dimethyldisulfane |
| | | 1,1,2-trioxide |
| Dialkyl-disulfone Or 1,2 alkyl-alkyl- disulfane 1,1,2,2-tetraoxide | (R—SOO—SOO—R′) | 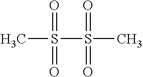 |
| | | 1,2-Dimethyldisulfane |
| | | 1,1,2,2-tetraoxide |
| Alkyl- sulfoxidesulfonate | (R—SO—SOO—OH) | 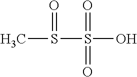 |
| | | Methylsulfanesulfonic |
| | | acid oxide |
| Alkyl- sulfonesulfonate | (R—SOO—SOO—OH) | 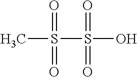 |
| | | 1-Hydroxy-2- |
| | | methyldisulfane |
| | | 1,1,2,2-tetraoxide |
| Alkyl- sulfoxidesulfinate | (R—SO—SO—OH) | 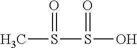 |
| | | 1-Hydroxy-2- |
| | | methyldisulfane |
| | | 1,2-dioxide |
| Alkyl- sulfonesulfinate | (R—SOO—SO—OH) | 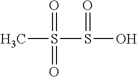 |
| | | Methylsulfanesulfinic |
| | | acid dioxide |

R and R′ can be the same or different C1-C10 alkyl groups or C6-C10 aryl groups comprising

TABLE 3

| | ODSO/ | ODSO/ | Free | | | Distilled |
|---|---|---|---|---|---|---|
| | NH₄F | F⁻ ratio | water sub. | TPABr | NH₄F | water |
| Ex. | (wt. %/wt. %) | (wt. %/wt. %) | (%) | g (98 wt. %) | g (98 wt. %) | g |
| Comp | 0 | 0 | 0 | 0.7542 | 1.3113 | 12.4510 |
| 1 | 1.19 | 2.32 | 12.5 | 0.7539 | 1.3115 | 10.9010 |
| 2 | 1.39 | 2.70 | 14.6 | 0.7537 | 1.3117 | 10.6420 |
| 3 | 1.58 | 3.08 | 16.7 | 0.7540 | 1.3118 | 10.3820 |
| 4 | 1.78 | 3.47 | 18.7 | 0.7544 | 1.3120 | 10.1230 |
| 5 | 1.97 | 3.84 | 20.8 | 0.7545 | 1.3116 | 9.8630 |
| 6 | 2.18 | 4.24 | 22.9 | 0.7543 | 1.3113 | 9.6040 |
| 7 | 2.23 | 4.35 | 23.5 | 0.7546 | 1.3114 | 9.5310 |
| 8 | 2.28 | 4.45 | 24.0 | 0.7539 | 1.3111 | 9.4690 |
| 9 | 2.33 | 4.54 | 24.5 | 0.7538 | 1.3109 | 9.4060 |
| 10 | 2.37 | 4.63 | 25.0 | 0.7536 | 1.3110 | 9.3440 |
| 11 | 2.41 | 4.70 | 25.4 | 0.7538 | 1.3115 | 9.2940 |
| 12 | 2.50 | 4.87 | 26.3 | 0.7545 | 1.3114 | 9.1820 |
| 13 | 2.58 | 5.03 | 27.2 | 0.7538 | 1.3113 | 9.0700 |
| 14 | 2.67 | 5.21 | 28.1 | 0.7542 | 1.3110 | 9.9950 |
| 15 | 2.97 | 5.79 | 31.3 | 0.7540 | 1.3113 | 8.5650 |
| 16 | 3.27 | 6.37 | 34.4 | 0.7543 | 1.3113 | 8.1760 |
| 17 | 3.57 | 6.96 | 37.5 | 0.7545 | 1.3109 | 7.7870 |
| 18 | 4.75 | 9.26 | 50.0 | 0.7543 | 1.3110 | 6.2290 |

| | Fumed | | | | Dried | |
|---|---|---|---|---|---|---|
| | Silica | ODSO | pH | pH | mass | |
| Ex. | g | g | (sol gel) | (supernatent) | g | Product |
| Comp | 2.0849 | 0 | 8.5 | 8.5 | 1.9136 | Silicalite-1 |
| 1 | 2.0840 | 1.5592 | 8.0 | 8.0 | 1.5705 | Silicalite-1 |
| 2 | 2.0861 | 1.8175 | 8.0 | 8.0 | 1.7201 | Silicalite-1 |
| 3 | 2.0833 | 2.0758 | 8.0 | 8.0 | 1.6288 | Silicalite-1 |
| 4 | 2.0841 | 2.3348 | 8.0 | 8.0 | 1.6131 | Silicalite-1 |
| 5 | 2.0846 | 2.5855 | 8.0 | 8.0 | 1.4758 | Silicalite-1 |
| 6 | 2.0833 | 2.8531 | 7.0 | 7.0 | 1.4775 | Silicalite-1 |
| 7 | 2.0849 | 2.9286 | 7.5 | 7.0 | 1.4768 | MFI * |
| 8 | 2.0848 | 2.9913 | 7.0-7.5 | 7.0 | 1.5254 | b-Oriented |
| 9 | 2.0844 | 3.0521 | 7.0-7.5 | 7.0 | 1.4535 | b-Oriented |
| 10 | 2.0843 | 3.1129 | 7.0 | 7.0 | 1.5678 | MFI * |
| 11 | 2.0848 | 3.1651 | 7.0 | 6.5-7.0 | 1.4250 | MFI * |
| 12 | 2.0851 | 3.2756 | 6.0 | 6.0 | 1.4093 | MFI * & amorphous |
| 13 | 2.0846 | 3.3849 | 5.0 | 5.0 | 1.3996 | MFI * & amorphous |
| 14 | 2.0845 | 3.5045 | 1.5-2.0 | 1.5 | 1.3891 | MFI * & amorphous |
| 15 | 2.0849 | 3.8957 | 0.0 | 0.0 | 1.3745 | b-Oriented MFI & |
| | | | | | | amorphous & unknown |
| 16 | 2.0846 | 4.2843 | 0.0 | 0.0 | 1.3944 | b-Oriented MFI & |
| | | | | | | amorphous & unknown |
| 17 | 2.0842 | 4.6787 | 0.0 | 0.0 | 1.4440 | b-Oriented MFI & |
| | | | | | | amorphous & unknown |
| 18 | 2.0843 | 6.2262 | 0.0 | 0.0 | 1.3992 | Amorphous & Unknown |

(MFI) * = a mixture of b-Oriented & Silicalite-1 MFI zeolite

1. A method for synthesis of b-oriented MFI zeolite comprising:
forming a homogeneous aqueous mixture of precursors and reagents effective for synthesis of MFI zeolite, including a fluoride-containing mineralizer, and water-soluble oxidized disulfide oil (ODSO); and
heating the mixture under conditions and for a time effective to form a precipitate suspended in a supernatant, wherein the precipitate comprises b-oriented MFI zeolite.

2. The method of claim 1, wherein the b-oriented MFI zeolite is a pure silica zeolite.

3. A method to induce b-orientation in MFI zeolites by using oxidized disulfide oil (ODSO) as a sol-gel component in the presence of a fluoride anion to induce b-orientation in MFI zeolites.

4. The method of claim 3, wherein the sol-gel also comprises a silica source, an organic template and optionally an aluminum source.

5. The method of claim 3, wherein the zeolite is Silicalite-1 having the MFI structure.

6. The method of claim 3, wherein the zeolite is ZSM-5 having the MFI structure.

7. The method of claim 6, wherein the ZSM-5 is a high-silica version.

8. The method of claim 3, wherein Silicalite-1 (MFI) converts to b-oriented Silicalite-1 (MFI) in the presence of ODSO.

9. The method of claim 1, wherein the fluoride-containing mineralizer is a compound that yields F⁻.

10. The method of claim 1, wherein the fluoride-containing mineralizer is a fluoride salt.

11. The method of claim 1, wherein the fluoride-containing mineralizer is selected from the group consisting of HF, NH₄F, NH₄HF₂, BF₃, NaF, KF, F₂, CHF₃, and combinations comprising two or more of the foregoing.

12. (canceled)

13. The method of claim 1, wherein the precursors and reagents comprise a silica source, an optional alumina source, and one of an optional structure directing agent or an optional seed material, and wherein the fluoride-containing mineralizer and the silica source are provided at a silicon to fluoride ratio (Si/F⁻) (mol./mol.) in the range of about 0.25-20.

14. The method of claim 13, wherein an amount of water-soluble ODSO is based on a ratio of ODSO to F⁻ (wt./wt.) of about 4.3-8.2.

15. The method of claim 13, wherein the water-soluble ODSO is provide in a pH-modified water-soluble ODSO composition comprising a composition of water-soluble ODSO and alkaline agent having an approximately neutral pH, and wherein an amount of the water-soluble ODSO is based on a ratio of pH-modified water-soluble ODSO to F⁻ (wt./wt.) of about 9.3-15.4.

16. The method of claim 13, wherein the precursors and reagents comprise a structure directing agent including one or more of quaternary ammonium cation compounds paired with an anion,
wherein the quaternary ammonium cation is selected from the group consisting of tetramethylammonium (TMA), tetraethylammonium (TEA), tetrapropylammonium (TPA), tetrabutylammonium (TBA) and cetyltrimethylammonium (CTA);
wherein the anion is selected from the group constating of a hydroxide anion, a bromide anion and an iodide anion.

17-18. (canceled)

19. The method of claim 1, wherein the ODSO is derived from oxidation of disulfide oil compounds present in an effluent refinery hydrocarbon stream recovered following catalytic oxidation of mercaptans present in a mercaptan-containing hydrocarbon stream.

20. (canceled)

21. The method of claim 1,
wherein the ODSO comprises 3 or more oxygen atoms and include one or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl; or
wherein the ODSO comprises 3 or more oxygen atoms and include two or more compounds selected from the group consisting of (R—SOO—SO—R′), (R—SOO—SOO—R′), (R—SO—SOO—OH), (R—SOO—SOO—OH), (R—SOO—SO—OH), (R′—SO—SO—OR), (R′—SOO—SO—OR), (R′—SO—SOO—OR) and (R′—SOO—SOO—OR), wherein R and R′ can be the same or different C1-C10 alkyl or C6-C10 aryl; or
wherein the ODSO comprises 3 or more oxygen atoms and include one or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl; or
wherein the ODSO comprises 3 or more oxygen atoms and include two or more compounds selected from the group consisting of (R—SOO—SO—R′), (R—SOO—SOO—R′), (R—SO—SOO—OH), (R—SOO—SOO—OH), (R—SO—SO—OH), (R—SOO—SO—OH), wherein R and R′ can be the same or different C1-C10 alkyl or C6-C10 aryl.

22. the method of claim 1, wherein the b-oriented MFI zeolite has enhanced diffusion with respect to that of a comparative zeolite formed in the absence of ODSO and of approximately equivalent compositional ratio, time and conditions effective for the zeolite.

23. The method of claim 1, wherein the b-oriented MFI zeolite has enhanced permeance and/or throughput with respect to that of a comparative zeolite formed in the absence of ODSO and of approximately equivalent compositional ratio, time and conditions effective for the zeolite.

24. The method of claim 1, wherein the b-oriented MFI zeolite has enhanced selectivity with respect to that of a comparative zeolite formed in the absence of ODSO and of approximately equivalent compositional ratio, time and conditions effective for the zeolite.
